(19) United States
(12) Patent Application Publication
(10) Pub. No.: US 2015/0237874 A1
(43) Pub. Date: Aug. 27, 2015

(54) System for producing end products by cutting flat blocks, in particular flat and hollow wafer blocks

(71) Applicant: HAAS FOOD EQUIPMENT GMBH, WIEN (AT)

(72) Inventors: Johannes Haas, Wien (AT); Josef Haas, Leobendorf (AT); Stefan Jiraschek, Koenigsbrunn (AT); Norbert Drapela, Langenzersdorf (AT); Erich Koletnik, Klosterneuburg/Kierling (AT)

(21) Appl. No.: 14/421,546

(22) PCT Filed: Jul. 22, 2013
(86) PCT No.: PCT/EP2013/065377

§ 371 Date: Feb. 13, 2015

(30) Foreign Application Priority Data
Aug. 16, 2012 (AT) A891/2012

(51) Int. Cl. A21C 15/04; B26D 3/18; B26D 7/06; B26D 1/553

(52) U.S. Cl. CPC A21C 15/04; B26D 1/553; B26D 3/18; B26D 7/0625

(57) ABSTRACT

A system for producing end product by cutting flat blocks, in particular flat and hollow wafer blocks. The system includes a main cutting station in which a contour cutting apparatus, which cuts the blocks through contour cuts transversely to a rectilinear transport path, is provided and which extends in longitudinal direction of the system. A main conveying device disposed along the transport path conveys the blocks through the contour cutting apparatus. At least one contour cutting module of the cutting apparatus is provided with at least one cutting tool that can be moved to and fro in the transverse direction of the system to produce a contour cut in the blocks passing the contour cutting apparatus in the longitudinal direction of the system.

The invention relates to a system for producing end products by cutting flat blocks, in particular flat and hollow wafer blocks.

In known systems designated as wafer block cutters, large-format rectangular wafer blocks (for example L×W=730×380 mm) are cut in two mutually perpendicular directions into many small wafer pieces which usually have a size which fits into the mouth (L×W×H=49×17×17 mm). The small wafer pieces are designated in practice as bars or wafer bars. Such systems are known, for example, from the documents AT 363 413 B, AT 412 250 B, GB 2 047 647 A, GB 2 348 356 A, GB 2 348 356 B, U.S. Pat. No. 4,359,920 A, U.S. Pat. No. 4,579,030 A, U.S. Pat. No. 6,415,698 B1. In the known systems only rectangular end products can be produced, which are delimited laterally by flat surfaces.

The invention proposes a new system for producing end products which are formed by the cutting of flat blocks, in particular of flat and hollow wafer blocks. In the system an input station for the blocks, at least one cutting station for cutting the products and a dispensing station for the end products are provided. In the system a main cutting station is provided in which a contour cutting apparatus which cuts the blocks through contour cuts is disposed transverse to a rectilinear transport path which extends in the longitudinal direction of the system through the main cutting station. A main conveying device is disposed along the transport path by which the blocks are conveyed along the transport path through the contour cutting apparatus. The contour cutting apparatus provides at least one contour cutting module which is provided with at least one cutting tool which can be moved to and fro in the transverse direction of the system, which produces a contour cut in the blocks passing the contour cutting apparatus in the longitudinal direction of the system.

When producing the contour cuts, the longitudinal movements of the blocks produced by the main conveying device are combined with the transverse movements of the cutting tool produced by the contour cutting apparatus. The combination of these movements is transferred to the cutting tool of the contour cutting apparatus and the cutting tool produces contour cuts in the blocks, whose profile is obtained from this movement combination.

In the system the longitudinal movements of the blocks and the transverse movements of the cutting tools can be varied differently during the production of the contour cuts. A new profile of the contour cut produced by the movement combination is obtained from each variation of one of these two movements. By different variation of these two movements, contour cuts can be produced which have subsections differing more or less from the longitudinal direction of the system. The subsections can have a rectilinear contour or an arcuate curved contour or a freely shaped contour. The subsections can be disposed parallel to the longitudinal direction of the system or obliquely thereto.

The blocks are moved in the longitudinal direction by the contour cutting apparatus whilst this moves its cutting tool or its cutting tools to and fro in the transverse direction. In this way, the new system can produce very differently running contour cuts in the blocks. The contour cuts are adapted with their differently running subsections to the outlines of the end products to be produced. The blocks are cut by the contour cuts and in so doing divided into end product and any block residues.

The system according to the invention enables the production of end products having very differently shaped outlines. End products can be cut out from the usually rectangular blocks by the contour cuts in which the outline corresponds, for example, to a slice of tart, a circular disk, a flat figure, a three-leaved clover leaf, a four-leaved clover leaf or a symbol. In the system according to the invention, rectangular or fan-shaped end products can also be produced in which the outline has rectilinear, circular-arc-shaped or wave-shaped subpieces.

The contour cutting module of the contour cutting apparatus can also have two or more cutting tools disposed adjacently in the transverse direction which cut two or more end products disposed adjacent to one another in the transverse direction from one block.

According to a further feature of the invention, it can be provided that the contour cutting apparatus comprises two contour cutting modules which are disposed consecutively in the longitudinal direction of the system and which produce two different contour cuts.

This configuration enables the blocks to be cut with two differently running contour cuts inside the blocks, where mutually opposite subsections of the two contour cuts mutually complement each other to form the outline of a complete end product. Each of the two contour cutting modules with its cutting tool moving to and fro in the transverse direction produces a half outline of the desired end product. The end products can be circular disks. The one contour cutting module produces with its cutting tool a contour cut in which one subsection corresponds to the left half of the circular outline. The other contour cutting module produces with its cutting tool a contour cut in which one subsection corresponds to the right half of the circular outline. The end products can also be diamonds where the contour cut produced by the one contour cutting module then includes two rectilinear subsections which correspond to the left diamond half and the contour cut produced by the second contour cutting module contains two rectilinear subsections which correspond to the right diamond half.

According to a further feature of the invention, it can be provided that the contour cutting apparatus comprises three contour cutting modules which are disposed consecutively in the longitudinal direction of the system and which produce three different contour cuts.

This configuration enables end products to be produced in the system according to the invention in which the outline consists of three subpieces each produced by one of the three contour cutting modules of the contour cutting apparatus. End products can be produced in which the outline consists of two obliquely running rectilinear subsections and one arcuate subsection.

According to the invention, the following can further be provided in the contour cutting apparatus.

The contour cutting module can be a cutting head which is movable in the transverse direction of the system and which carries at least one vertically disposed cutting tool which passes through the transport path of the blocks in the vertical direction.

In this configuration the cutting head is moved to and fro in the transverse direction of the system according to the profile of the contour cut whilst a block is pushed through the contour cutting apparatus in the longitudinal direction of the system. The cutting tool of the cutting head produces in the block a contour cut which consists of the combination of the longitudinal movements of the block with the transverse movements of the cutting head.

The cutting head can be disposed above the transport path of the blocks and at least carry one cutting tool which projects downwards therefrom and which passes through the transport path of the blocks located underneath it in the vertical direction.

The cutting head can be disposed below the transport path of the blocks and at least carry one cutting tool which projects upwards therefrom and which passes through the transport path of the blocks located above it in the vertical direction.

The cutting head can also have two or more cutting tools disposed adjacent to one another in the transverse direction which cut out two or more end products disposed adjacent to one another from one block.

According to the invention, the contour cutting module can comprise a drive module connected to the cutting head which during the contour cut produces movements of the cutting head running in the transverse direction of the system.

In a cutting head disposed above the transport path of the blocks, the drive module can be disposed above the cutting head or laterally adjacent to the cutting head. In a cutting head disposed below the transport path of the blocks, the drive module can be disposed below the cutting head or laterally adjacent to the cutting head.

The drive module connected to the cutting head can contain a contour template from which the movements of the cutting head running in the transverse direction of the system during the contour cut are taken. This configuration enables a rapid change of the contour cut produced by the cutting head by replacing the contour template.

The drive module connected to the cutting head can be coupled to a copying device which takes the contour of the end product from a contour template or an original model. In this configuration, the movements of the cutting head which determine the profile of the contour section and run in the transverse direction of the system can be taken directly from the contour template or from the original model.

In the drive module a movement device can be provided which moves the cutting head to and fro in the transverse direction of the system, which movement device is coupled to a drive motor in which the generation of the movements of the cutting head running in the transverse direction of the system during the contour cut is integrated in the control program of the drive motor.

A linear motor which moves the cutting head to and fro in the transverse direction of the system can be provided as drive module in which the generation of the movements of the cutting head running in the transverse direction of the system during the contour cut is integrated in the control program of the linear motor.

According to the invention, the following can further be provided in the contour cutting apparatus.

The contour cutting module can comprise a contour cutting frame which can be moved in the transverse direction of the system having at least one vertically disposed cutting wire and a drive module connected to the contour cutting frame which produces movements of the contour cutting frame running in the transverse direction of the system during the contour cut.

In this configuration the contour cutting frame is moved to and fro in the transverse direction of the system by the drive module connected thereto according to the profile of the contour cut, whilst a block is pushed through the contour cutting apparatus by the main conveying device in the longitudinal direction of the system. The contour cutting frame produces with its cutting wire a contour cut in the block which is formed by the combination of the movements of the contour cutting frame running in the transverse direction of the system with the movements of the block running in the longitudinal direction of the system.

The drive module which is connected to the contour cutting frame and which moves this to and fro in the transverse direction of the system can be disposed above the contour cutting frame. The drive module can also be disposed below the contour cutting frame or laterally adjacent to this.

The drive module connected to the contour cutting frame can contain a contour template from which movements of the contour cutting frame running in the transverse direction of the system are taken during the contour cut. This configuration enables a rapid change of the contour cut produced by the contour cutting frame by replacing the contour template.

The drive module connected to the contour cutting frame can be coupled to a copying device which takes the contour of the end product from a contour template or an original model. In this configuration the movements of the contour cutting frame which determine the contour cut and which run in the transverse direction of the system can be taken directly from the contour template or from the original model.

In the drive module a movement device coupled to a drive motor can be provided which moves the contour cutting frame to and fro in the transverse direction of the system and the generation of the movements of the contour cutting frame running in the transverse direction of the system during the contour cut can be integrated in the control program of the drive motor. The drive motor can be configured as a servo motor and the movement device can be configured as a recirculating ball screw drive extending in the transverse direction of the system.

A linear motor which moves the contour cutting frame to and fro in the transverse direction of the system can be provided as the drive module, in which the generation of the movements of the contour cutting frame running in the transverse direction of the system during the contour cut is integrated in the control program of the linear motor.

The contour cutting frame can contain two or more vertically disposed cutting wires which are disposed at a distance from one another in the transverse direction of the system.

According to a further feature of the invention, it can be provided that the contour cutting apparatus provides at least one additional cutting module which is provided with at least one stationary cutting tool which produces a straight cut parallel to the longitudinal direction of the system in the blocks. The additional cutting module can be provided with a stationary cutting frame which contains at least one substantially vertically disposed cutting wire.

According to the invention, the following can further be provided in the main cutting station.

A rear contact plate can be mounted directly upstream of the contour cutting apparatus. Above the rear contact plate there can be provided an optionally height-adjustable upper plate which delimits the transport path at the top. This plate prevents tipping of the blocks lying on the rear contact plate whilst these are pushed through the contour cutting apparatus. Above the rear contact plate there can be provided at least one guide strip which delimits the transport path laterally. Optionally at least one guide strip can be disposed on both sides of the transport path. In this configuration the blocks can be supported laterally on a guide strip when passing the contour cutting apparatus.

A front contact plate can be disposed directly downstream of the contour cutting apparatus. An optionally height-adjustable upper plate which delimits the transport path at the top can be provided above the front contact plate. This plate prevents tipping of the end products and block residues emerging from the contour cutting apparatus. At least one guide strip which delimits the transport path laterally can be provided above the front contact plate. Optionally at least one guide strip can be disposed on both sides of the transport path. In this configuration the blocks emerging from the contour cutting apparatus can be supported laterally on the guide strip.

In a further configuration of the invention, the following can be provided. The system is provided with a rectilinear transport path running in the longitudinal direction of the system, which extends from the input station through the main cutting station into the dispensing station. The contour cutting apparatus is disposed in the main cutting station transversely to the rectilinear transport path. An endless product conveyor belt is located downstream of the contour cutting apparatus, which receives the end products and extends along the rectilinear transport path into the dispensing station of the system.

This configuration provides an in-line design of the system according to the invention. Input station, main cutting station and main dispensing station are disposed consecutively in a straight line in the longitudinal direction of the system. The blocks are conveyed along the rectilinear transport path from the input station into the conveying station. On passing the main cutting station the blocks are cut by the contour cuts produced by the contour cutting apparatus and divided into end products and block residues. The end products and block residues are taken from the product conveyor belt and transported to the dispensing station. As a result of the in-line design a relatively small overall width of the entire system can be achieved which is advantageous when the space conditions at the installation site of the system are restricted.

In the in-line design of the system the following can further be provided.

An optionally height-adjustable upper plate which delimits the transport path at the top can be provided above the product conveyor belt. The upper plate prevents tipping of the end products and block residual pieces emerging from the contour cutting apparatus.

At least one guide strip which delimits the transport path laterally can be provided above the product conveyor belt. Optionally at least one guide strip can be disposed on both sides of the transport path. In this configuration the blocks emerging from the contour cutting apparatus can be supported laterally on a guide strip.

Also in the in-line design of the system a rear contact plate can be mounted directly upstream of the contour cutting apparatus. A hold-down device which delimits the transport path of the blocks at the top and which is optionally adjustable in height can be disposed above the rear contact plate. The hold-down device prevents tipping of the blocks lying on the rear contact plate whilst these are pushed through the contour cutting apparatus. At least one guide strip which delimits the transport path laterally can be provided above the rear contact plate. Optionally at least one guide strip can be provided on both sides of the transport path. In this configuration the blocks can be supported laterally on a guide strip when passing the contour cutting apparatus.

In the in-line design of the system, a first cutting station which cuts the blocks in the transverse direction of the system can be mounted upstream of the main cutting station, in which a first cutting apparatus having blades which can be moved to and fro transversely to the transport path is provided.

In this configuration the blocks are conveyed along the rectilinear transport path from the input station through the first cutting station to the main cutting station. In the first cutting station the stationary blocks lying on the transport path are cut into strips in the transverse direction of the system by the blades of the first cutting apparatus which can be moved to and fro transversely to the transport path. Strips which are elongated in the transverse direction of the system are thereby produced, these being disposed consecutively in the longitudinal direction of the system. The strips are conveyed along the rectilinear transport path to the main cutting station. There the strips are cut by the contour cuts produced by the contour cutting apparatus. The profile of the contour cuts is adapted to the outline of the end products to be produced. Thus, end products having an outline produced by the contour cuts are formed during the cutting of the strips. The end products and any cutting residues are removed from the main cutting station along the rectilinear transport path. In this way, rectangular blocks can be cut into small end products which, as a result of their small size, can be disposed inside a rectangular block with several in a transverse row adjacent to one another and in several rows one behind the other. The rectangular blocks are cut into strips in the transverse direction of the system in the first cutting station, which each correspond to one transverse row of end products. The strips are conveyed in the longitudinal direction of the system through the main cutting station and there cut into the individual final products by the contour cuts produced by the contour cutting apparatus.

According to the invention, the following can be provided in the main cutting station.

A main cutting station can be provided in which a rear contact plate and a transport unit of the main conveying device are mounted upstream of the contour cutting apparatus, wherein the transport unit moves the blocks forwards along the rectilinear transport path in the longitudinal direction of the system and has a rear block slider which is displaceable along the rear contact plate in the longitudinal direction of the system.

In this configuration the blocks are supplied to the main cutting station in the transverse direction of the system. In the main cutting station the blocks lie on the rear contact plate between the rear block slider and the contour cutting apparatus. The blocks are pushed by the transport unit with the aid of the rear block slider along the rectilinear transport path through the contour cutting apparatus. During passage through the contour cutting apparatus the blocks are cut by the contour cuts produced by the contour cutting apparatus. Here the end products are cut out from the blocks. The end products produced by cutting the blocks have an outline produced by the contour cuts and corresponding to the profile of the contour cuts. The end products emerge from the contour cutting apparatus on the front side of the contour cutting apparatus.

According to the invention, an endless product conveyor belt can be located downstream of the contour cutting apparatus which receives the end products and extends into the dispensing station of the system. In this configuration the end products emerging from the contour cutting apparatus in the longitudinal direction of the system are removed in the longitudinal direction of the system.

According to the invention, a front contact plate located downstream of the contour cutting apparatus and a transverse slider which is displaceable along the front contact plate in the transverse direction of the system can be provided. In this configuration the end products emerging from the contour cutting apparatus in the longitudinal direction of the system are removed in the transverse direction of the system.

According to the invention, the following can be provided in the main cutting station.

The contour cutting apparatus is disposed between a rear contact plate and a front contact plate. The main conveying device provides a first transport unit upstream of the rear contact plate and a second transport unit downstream of the front contact plate. The first transport unit moves the blocks forwards in the longitudinal direction of the system and is provided with a rear block slider which is displaceable along the rear contact plate in the longitudinal direction of the system. The second transport unit moves the blocks backwards in the longitudinal direction of the system and is provided with a front block slider which is displaceable along the front contact plate in the longitudinal direction of the system.

This configuration of the main cutting station allows contour cuts to be produced in the blocks in which on passing through the contour cutting apparatus, the blocks can be moved only forwards or forwards and backwards by the two transport units in the main conveying direction in the longitudinal direction of the system. On passing through the contour cutting apparatus, the blocks are cut into the individual end products by at least one cutting tool of the contour cutting apparatus which is moved to and fro in the transverse direction of the system.

The main cutting station equipped with two transport units can be equipped with a contour cutting apparatus which has only a single contour cutting module which has only a single cutting tool which is moved to and fro by the contour cutting module in the transverse direction of the system.

This configuration of the main cutting station allows end products to be cut from the blocks with a single contour cut. The profile of the contour cut produced by the cutting tool of the contour cutting apparatus is adapted to the outline of the end product to be produced. The cutting tool is moved to and fro by the contour cutting module in the transverse direction of the system whilst a block is moved forwards and backwards by the two transport units of the main conveying device in the longitudinal direction of the system. A half of the contour cut is produced by the forward movement of the block, the other half is produced during the backwards movement of the block. The block is pushed forwards from the rear contact plate onto the front contact plate and from the front contact plate back onto the rear contact plate. For producing a contour cut which corresponds to the circumference of a circular disk, the block is moved once forwards and once backwards. For producing a contour cut which corresponds to the irregular circumference of a four-leaf clover leaf, the block is moved multiply forwards and backwards during the production of the first half of the contour cut and also during the production of the second half of the contour cut. After executing the contour cut, the cut block together with the end product lies on the rear contact plate. For removal of the cut blocks and the end products from the main cutting station a transverse slider which is displaceable along the rear contact plate in the transverse direction of the system can be provided. In the contour cutting apparatus the contour cutting module can have two or more cutting tools disposed adjacent to one another in the transverse direction of the system, which are moved to and fro by the contour cutting module in the transverse direction of the system. The cutting tools cut out from one block two or more end products disposed adjacent to one another in the transverse direction of the system such as, for example four-leaf clover leaves or circular disks.

The main cutting station equipped with two transport units can be equipped with a contour cutting apparatus which contains two contour cutting modules disposed one behind the other in the longitudinal direction of the system, which each have only a single cutting tool which is moved to and fro by the respective contour cutting module in the transverse direction of the system.

This configuration of the main cutting station allows end products having two simultaneously executed contour cuts to be cut from the blocks. The contour cuts are produced by the contour cutting modules which are moved to and fro independently of one another in the transverse direction of the system. The two contour cutting modules produce in each block two separate contour cuts running differently in the block. Both contour cuts begin at the front edge of the block and end at the rear edge of the block. The two contour cuts contain subsections which lie opposite one another inside the block and mutually complement one another to form the complete outline of the end product. The one contour cut produces the left half of the outline of the end product and the other contour cut produces the right half of the outline of the end product. When producing the outline of a circular disk, the block is only moved forwards in the longitudinal direction of the system by the two transport units of the main conveying device. When producing the outline of a four-leaf clover leaf, the block is moved forwards and backwards by the two transport units of the main conveying device in the longitudinal direction of the system. During the backwards movement of the block those subsections of the clover leaf outline which have a backward-running contour contrary to the direction of advance of the blocks are produced. After executing the two contour cuts, the cut block together with the end product lies on the front contact plate. For removal of the cut blocks and end products, a transverse slider which is displaceable along the front contact plate in the transverse direction of the system can be provided.

According to the invention, the following can be provided in the main conveying device.

In the first transport unit there can be provided a drive module connected to the rear block slider which during the contour cut produces movements of the rear block slider running in the longitudinal direction of the system.

A movement device coupled to a drive motor can be provided in the drive module of the first transport unit, which moves the rear block slider to and fro in the longitudinal direction of the system and the generation of the movements of the rear block slider running in the longitudinal direction of the system during the contour cut can be integrated in the control program of the drive motor.

In the drive module of the first transport unit the drive motor can be configured as a servo motor and a movement device can be provided, which is configured as a recirculating ball screw drive which extends in the longitudinal direction of the system.

The first transport unit can be provided with a linear motor coupled to the rear block slider which moves the rear block slider to and fro in the longitudinal direction of the system in which the generation of the movements of the rear block slider running in the longitudinal direction of the system during the contour cut is integrated in the control program of the linear motor.

A drive module connected to the front block slider can be provided in the second transport unit, which produces the movements of the front block slider running in the longitudinal direction of the system during the contour cut.

In the drive module of the second transport unit there can be provided a movement device coupled to a drive motor which moves the front block slider to and fro in the longitudinal direction of the system and the generation of the movements of the front block slider running in the longitudinal direction of the system during the contour cut can be integrated in the control program of the drive motor.

In the drive module of the second transport unit there can be provided a drive motor configured as a servo motor and a movement device which is configured as a recirculating ball screw drive which extends in the longitudinal direction of the system.

The second transport unit can be provided with a linear motor coupled to the front block slider which moves the front block slider to and fro in the longitudinal direction of the system in which the generation of the movements of the front block slider running in the longitudinal direction of the system during the contour cut is integrated in the control program of the linear motor.

In a further embodiment of the invention, the following can be provided.

According to the invention, a feed device which feeds the blocks to the rear contact plate of the main cutting station in the transverse direction of the system can be provided.

A first cutting station which cuts the blocks in the transverse direction of the system can be provided, in which the blocks are pushed in the transverse direction of the system through a stationary cutting apparatus. The first cutting station is mounted upstream of the main cutting station in the transverse direction of the system. The blocks emerging from the first cutting station in the transverse direction of the system are fed to the main cutting station in the transverse direction of the system.

The first cutting station can be provided with a cutting apparatus which is disposed transversely to the direction of movement of the blocks and extends in the longitudinal direction of the system. The cutting apparatus can have two or more cutting tools disposed at a distance from one another in the longitudinal direction of the system.

In the cutting apparatus of the first cutting station a stationary circular saw can be provided as cutting tool which has a circular saw blade rotating about a horizontal axis.

The cutting apparatus of the first cutting station can be provided with a stationary cutting frame which extends in the longitudinal direction of the system and contains two or more substantially vertically disposed cutting wires.

The cutting apparatus of the first cutting station can be provided with two cutting tools located in the longitudinal direction of the system at a greater distance from one another which only trim the edges running in the transverse direction of the system or cut a narrow edge strip from the block there from the blocks passing through the cutting apparatus.

The cutting apparatus of the first cutting station can be provided with a plurality of cutting tools disposed at regular intervals in the longitudinal direction of the system. These cutting tools cut the blocks into individual strips which extend in the transverse direction of the system and are disposed consecutively in the longitudinal direction of the system.

The first cutting station can be provided with a block slider which can be moved in the transverse direction of the system which conveys the blocks lying on a horizontal transport plan in the transverse direction of the system through the stationary cutting apparatus.

The invention is explained in detail hereinafter by reference to some exemplary embodiments.

Some exemplary embodiments are shown in the appended drawings, in the figures:

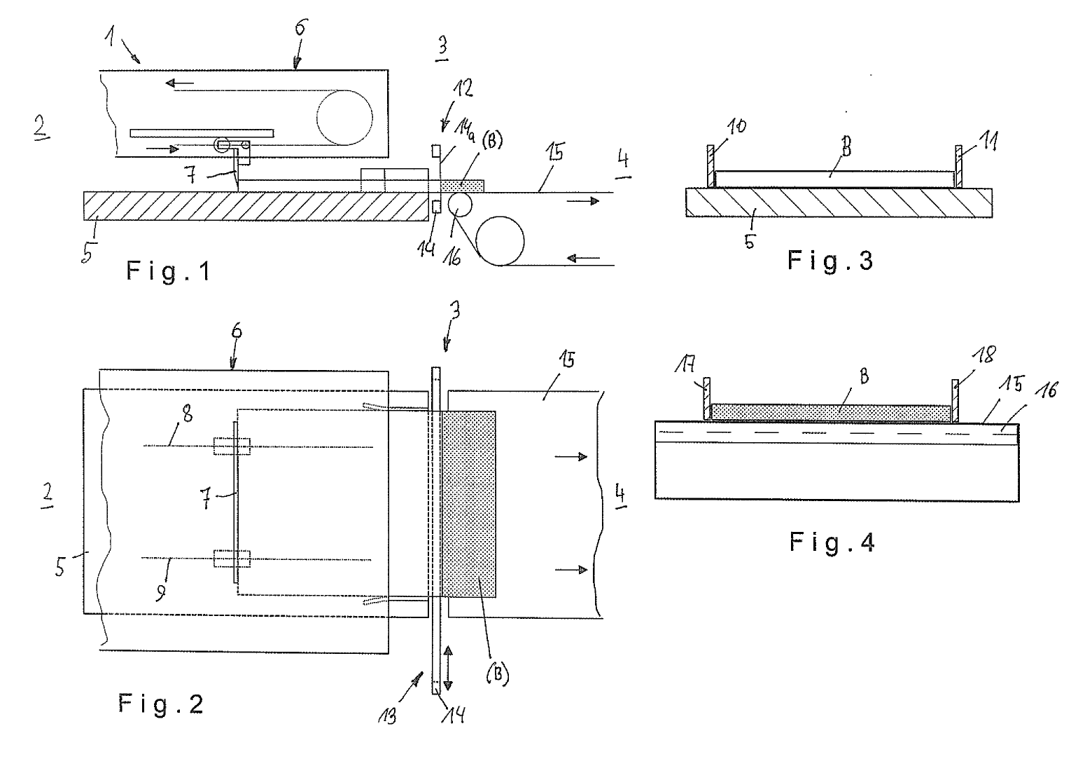

FIG. 1 shows a first variant of the system in longitudinal section

FIG. 2 shows a plan view of the system from FIG. 1

FIG. 3 shows a first detail of the system from FIG. 1 in cross-section

FIG. 4 shows a second detail of the system from FIG. 1 in cross-section

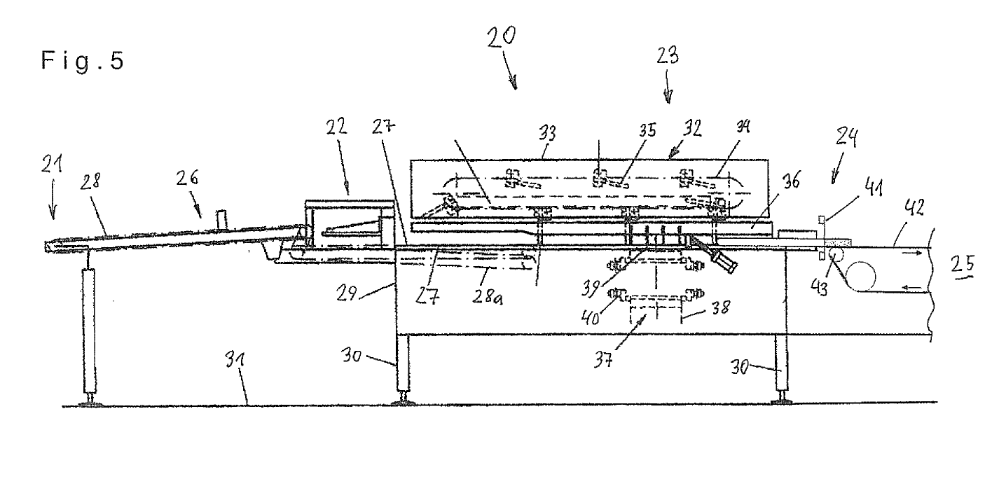

FIG. 5 shows a second variant of the system in longitudinal section

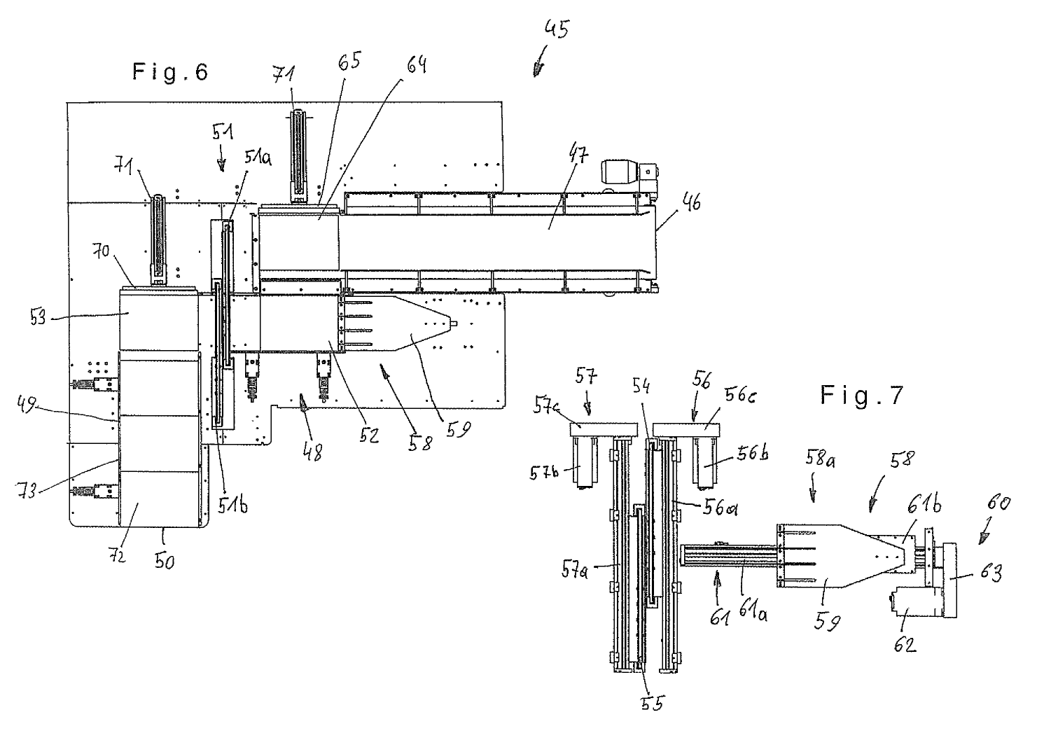

FIG. 6 shows a third variant of the system in plan view

FIG. 7 shows a detail of the system from FIG. 6 in plan view

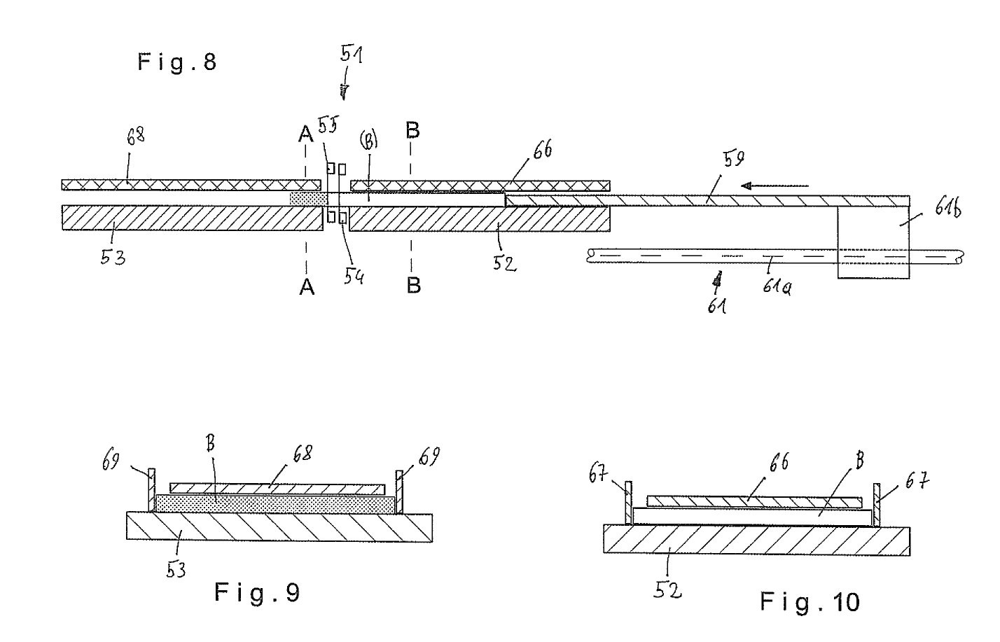

FIG. 8 shows a detail of the system from FIG. 6 in longitudinal section

FIG. 9 shows a detail of the system from FIG. 6 in cross-section

FIG. 10 shows a detail of the system from FIG. 6 in cross-section

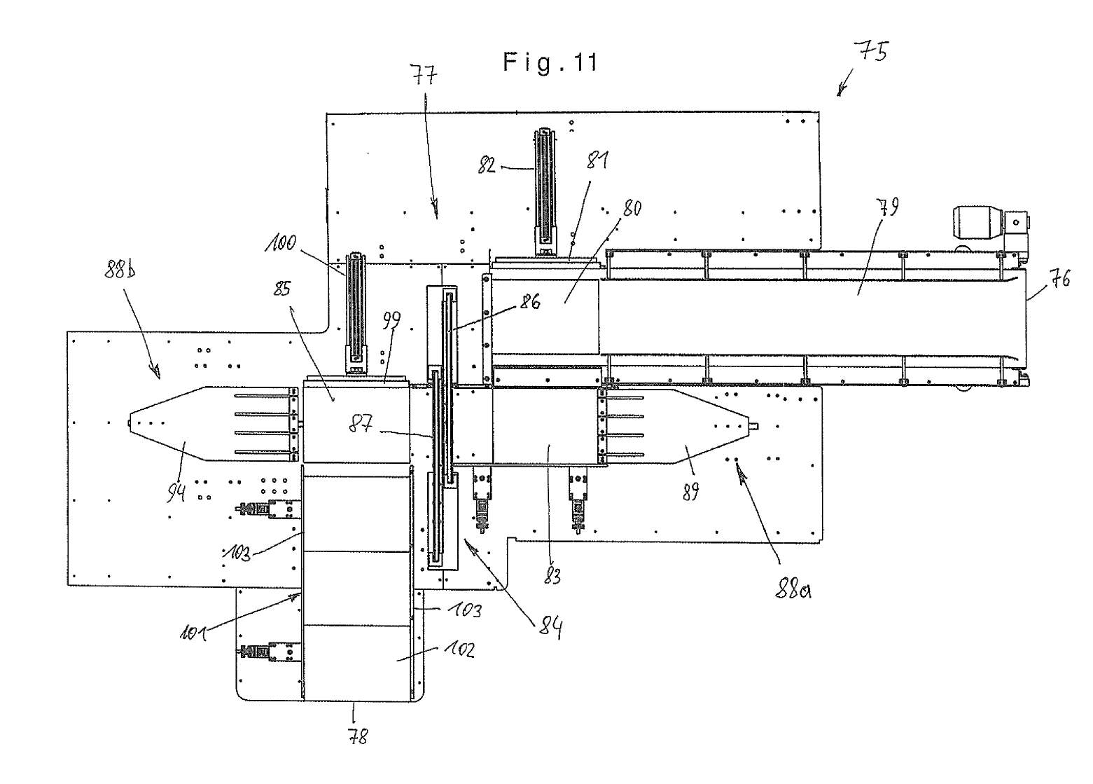

FIG. 11 shows a fourth variant of the system in plan view

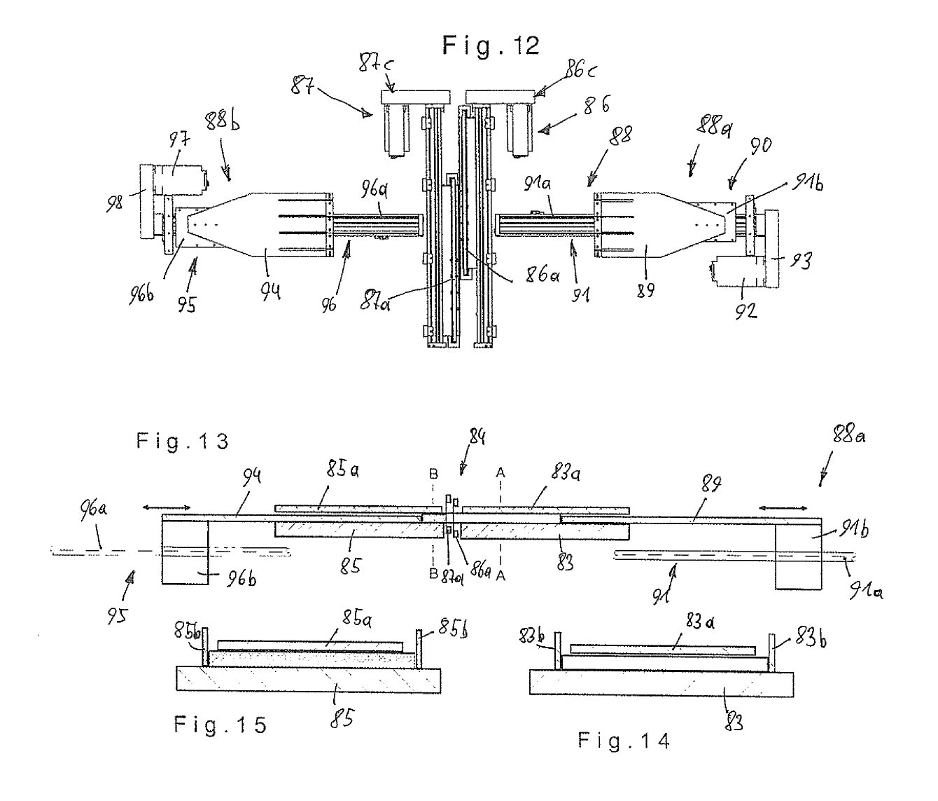

FIG. 12 shows a detail of the system from FIG. 11 in plan view

FIG. 13 shows a detail of the system from FIG. 11 in longitudinal section

FIG. 14 shows a detail of the system from FIG. 11 in cross-section

FIG. 15 shows a detail of the system from FIG. 11 in cross-section

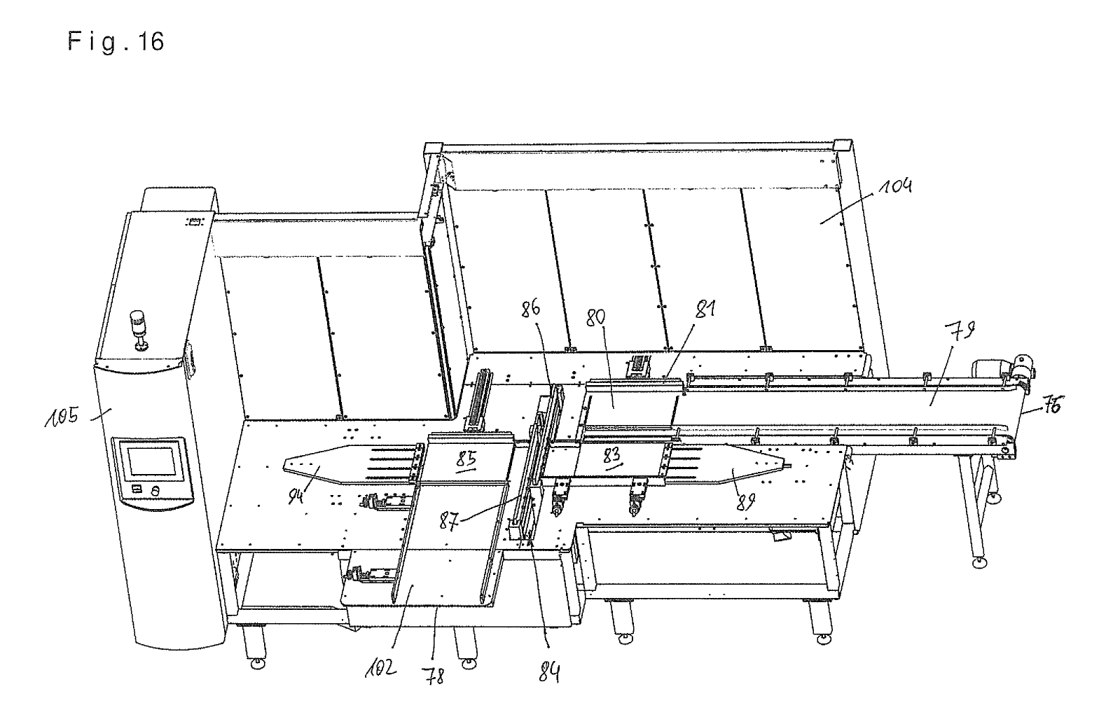

FIG. 16 shows the system from FIG. 11 in a three-dimensional view

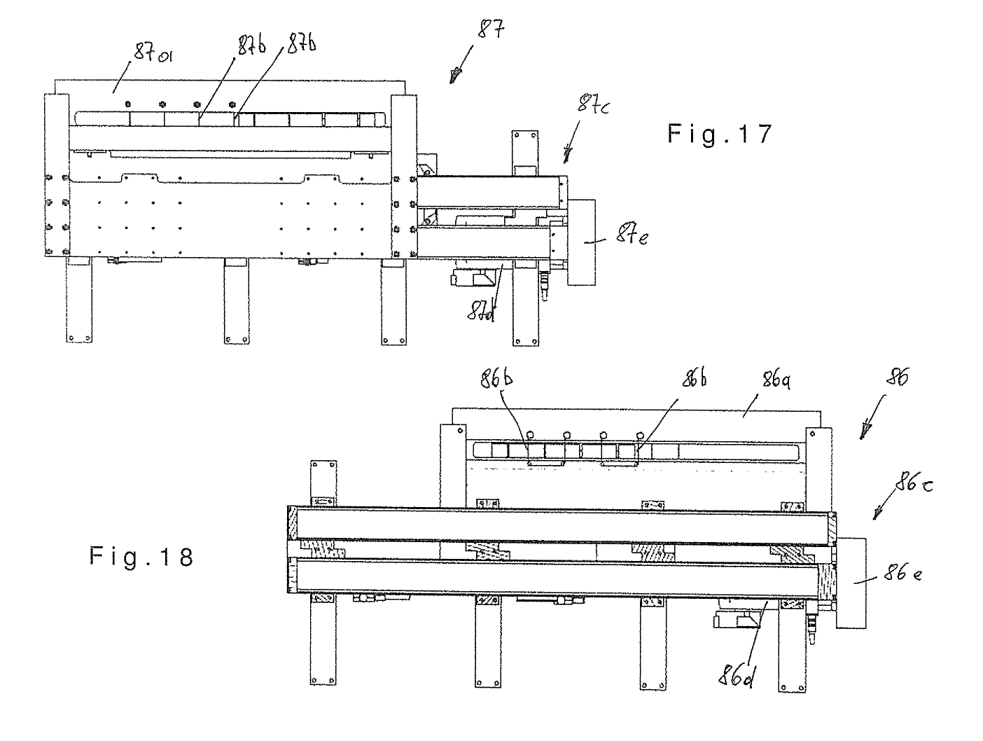

FIG. 17 shows a detail of the system from FIG. 11 in outline

FIG. 18 shows a detail of the system from FIG. 11 in outline

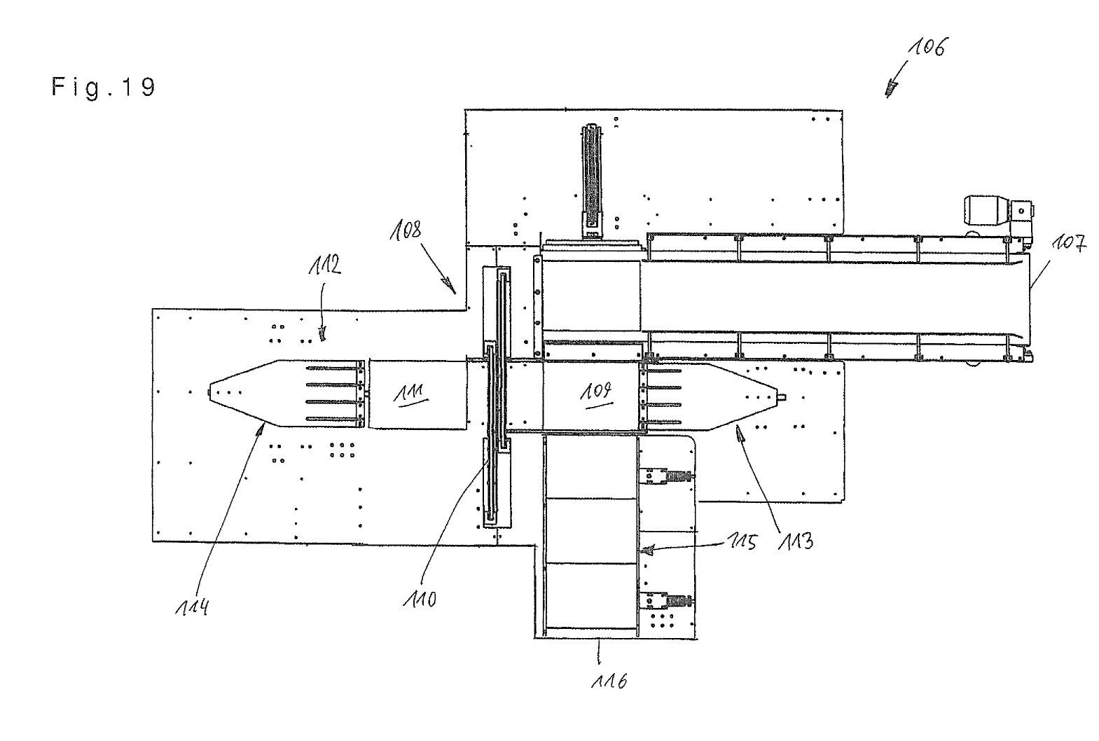

FIG. 19 shows a fifth variant of the system in plan view

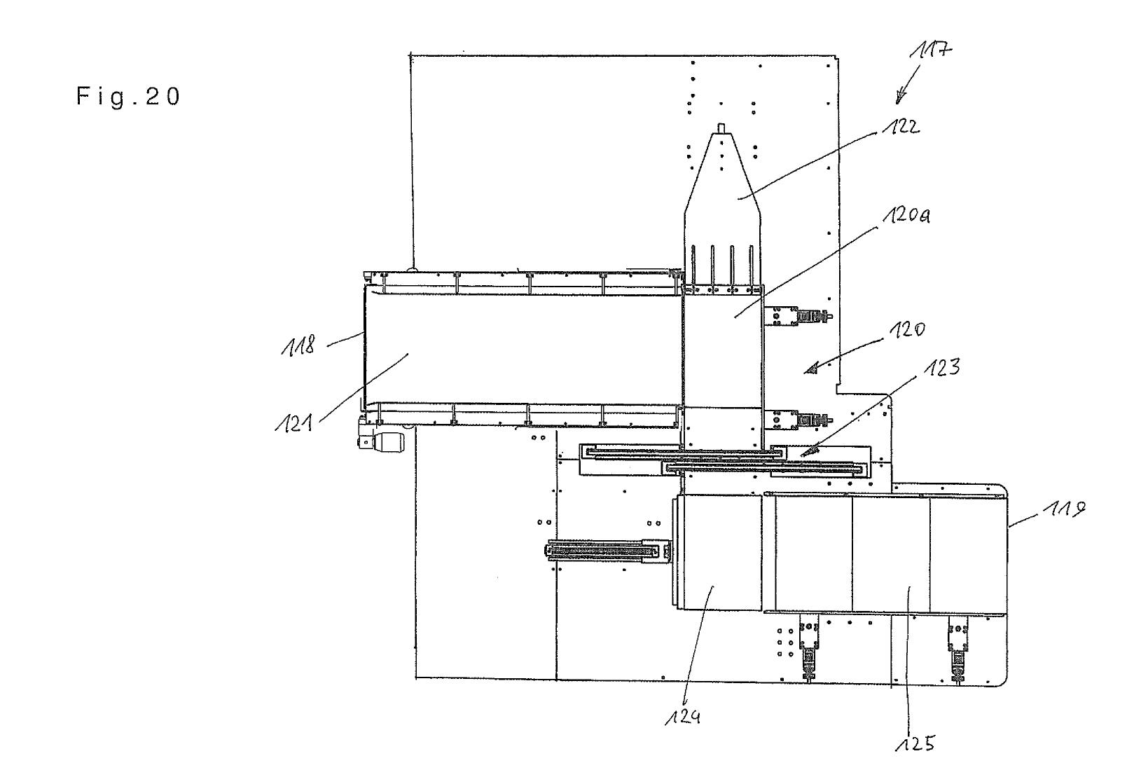

FIG. 20 shows a sixth variant of the system in plan view

FIG. 21 shows a seventh variant of the system in plan view

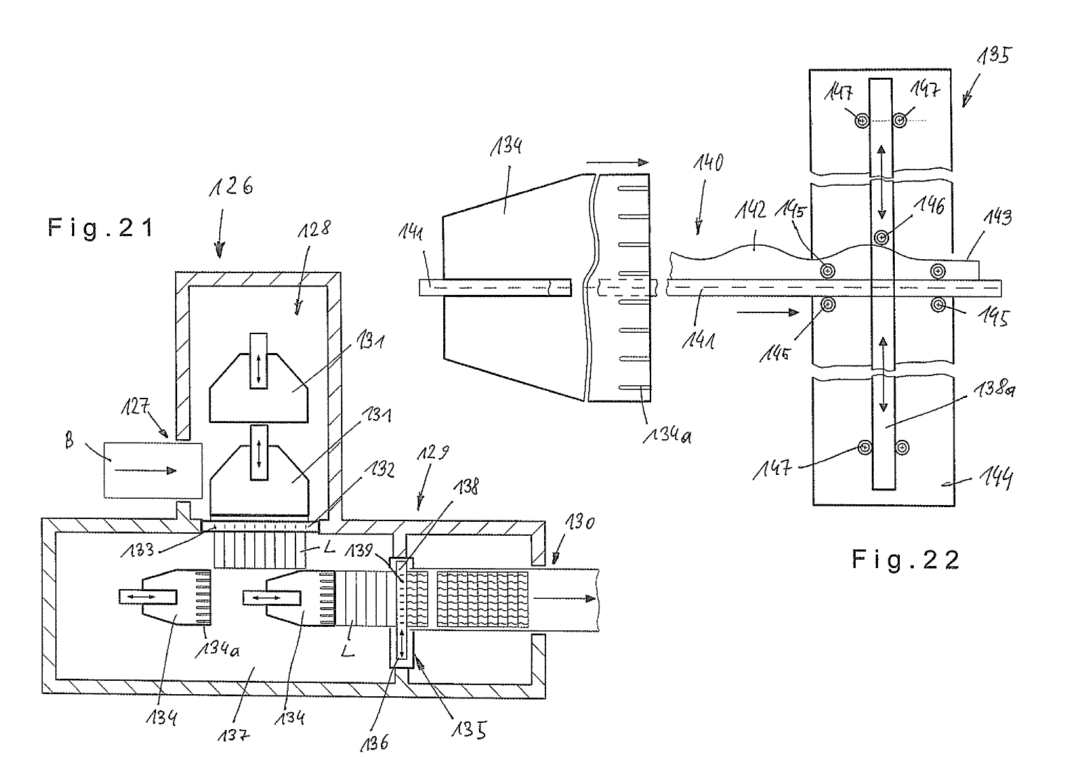

FIG. 22 shows details of the system from FIG. 21 in enlarged view

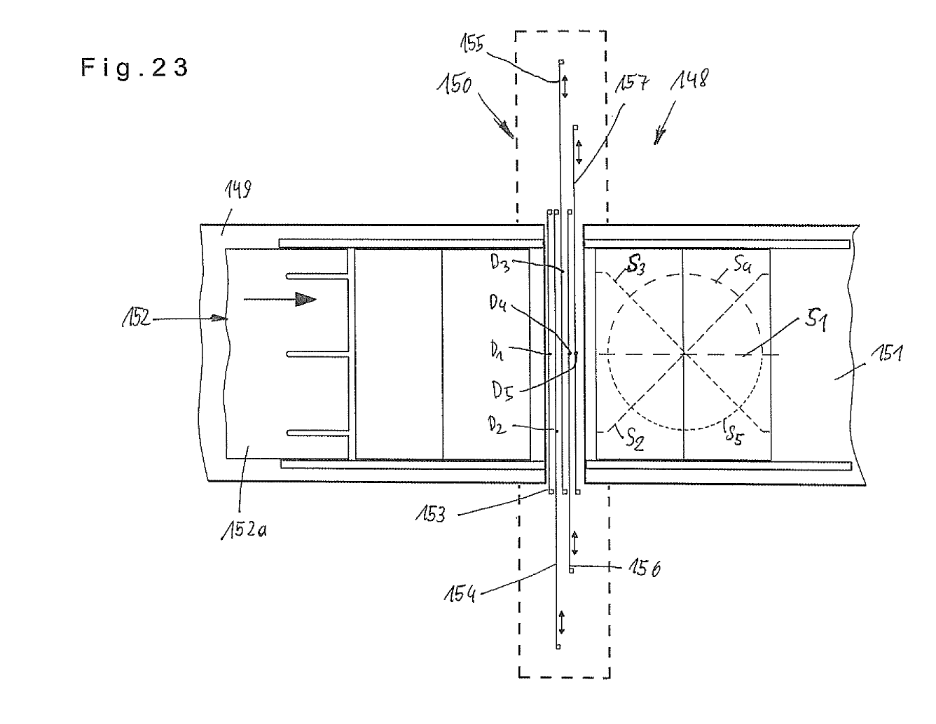

FIG. 23 shows a variant of the main cutting station in plan view

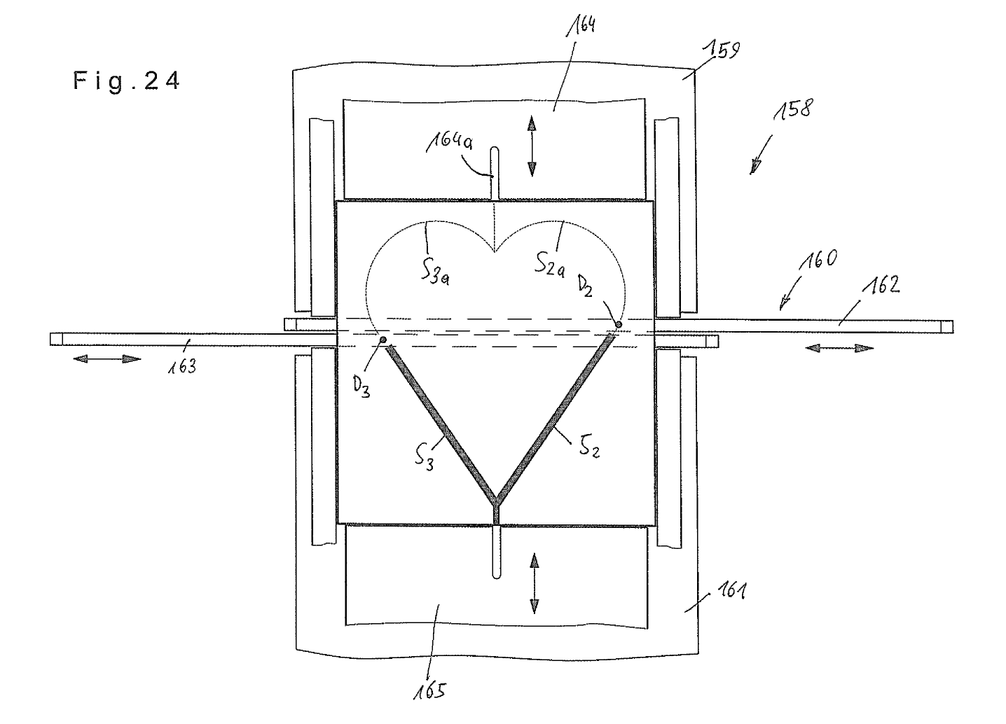

FIG. 24 shows a variant of the main cutting station in plan view

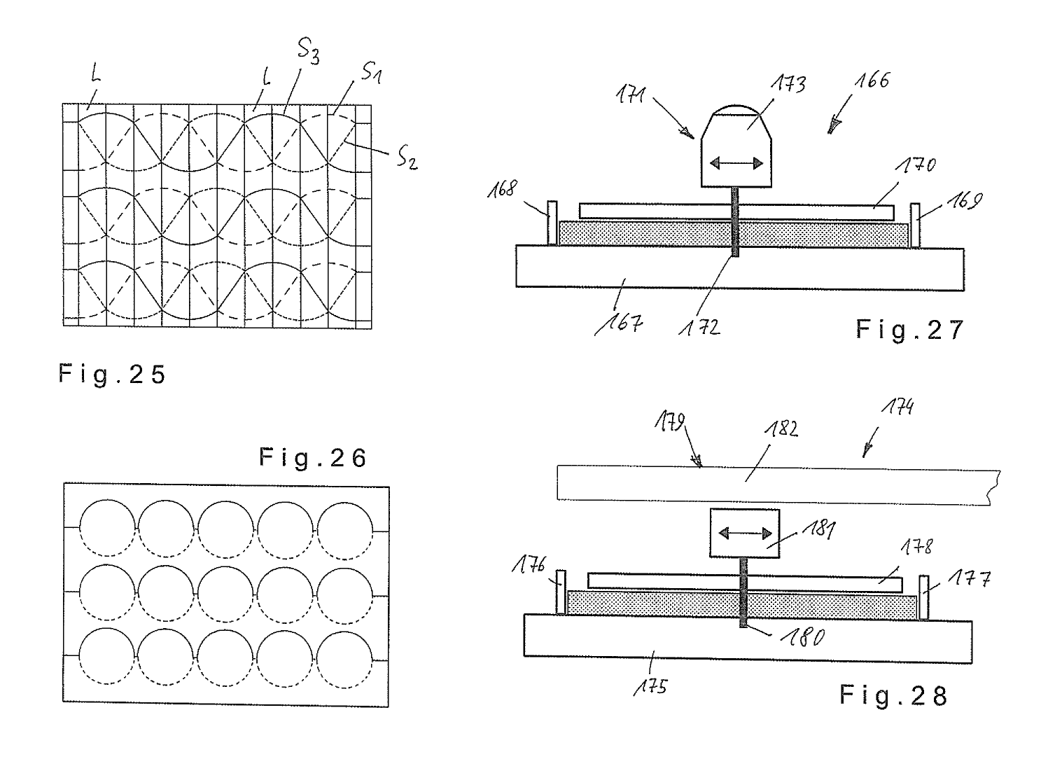

FIG. 25 shows a cut block in plan view

FIG. 26 shows a cut block in plan view

FIG. 27 shows a variant of the contour cutting apparatus in outline

FIG. 28 shows a variant of the contour cutting apparatus in outline

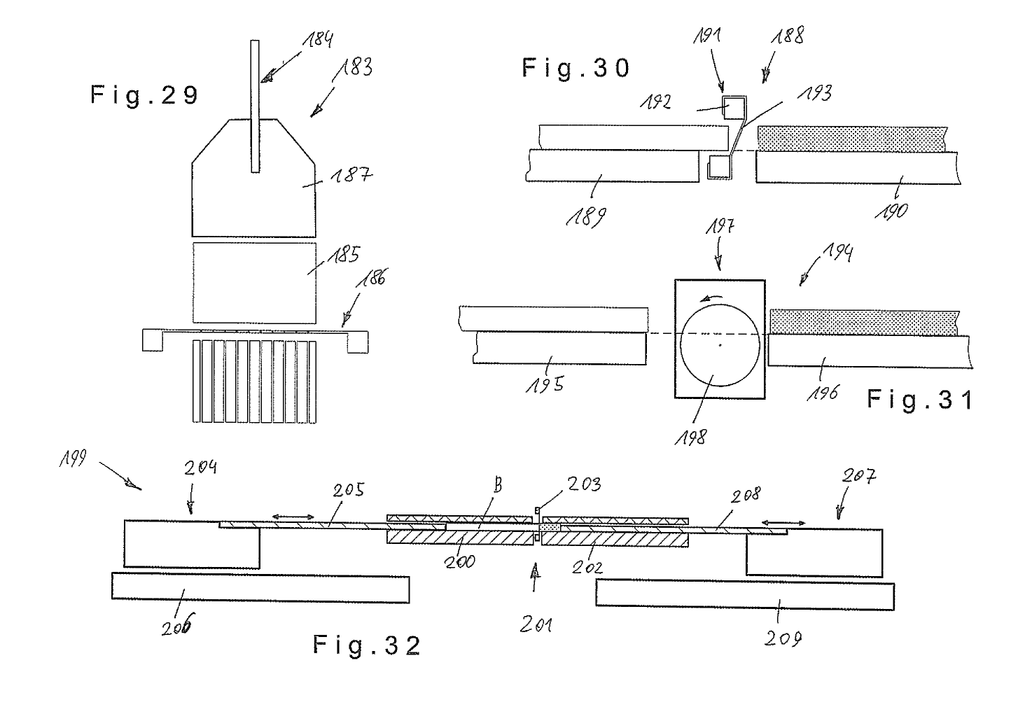

FIG. 29 shows a variant of a transverse cutting station in plan view

FIG. 30 shows a variant of a transverse cutting station in longitudinal section

FIG. 31 shows a variant of a transverse cutting station in longitudinal section and

FIG. 32 shows a variant of the main cutting station in longitudinal section

The invention provides a system in which flat blocks such as, for example, flat or hollow wafer blocks are cut by contour cuts. End products are cut out from the blocks by the contour cuts in which the shape of the outlines is determined by the profile of the contour cuts. The profile of the contour cuts is adapted, at least in sections, to the outline contour of the end products.

The contour cuts are executed by cutting tools which are moved to and fro in the transverse direction of the system whilst the blocks are moved in the longitudinal direction of the system. When producing contour cuts, the transverse movements of the cutting tools are combined with the longitudinal movements of the blocks. The particular combination of the transverse movements of the cutting tools with the longitudinal movements of the blocks determines the profile of the contour cuts produced by the cutting tools in the blocks. The transverse movements of the cutting tools are produced separately from the longitudinal movements of the blocks. The separate production of the two movements allows differently shaped contour cuts to be produced. Contour cuts comprising rectilinear, circular-arc-shaped or wave-shaped subpieces can be produced. Contour cuts which are adapted to the outline contours of differently shaped end products can be produced. These end products can, for example, have the shape of a slice of tart, a circular disk, a three-leaved clover leaf, a four-leaved clover leaf.

The contour cuts are executed in the main cutting station of the system. A rectilinear transport path for the blocks is provided in the main cutting station. The transport path extends in the longitudinal direction of the system. A main conveying device is disposed along the transport path. This conveys the blocks on the transport path in the longitudinal direction of the system. A contour cutting apparatus is disposed transversely to the transport path. This provides at least one contour cutting module which has at least one cutting tool which can be moved in the transverse direction of the system.

The blocks are pushed by the main conveying device along the transport path through the contour cutting apparatus. On passing through the contour cutting apparatus, the blocks are cut by the cutting tool moved to and fro in the transverse direction of the system by the contour cutting module. The cutting tool moved to and fro in the transverse direction of the system produces a cut or contour cut in a block moving in the longitudinal direction of the system, which has a profile which has been formed by the combination of the transverse movements of the cutting tool with the longitudinal movements of the block.

The blocks are supplied to the system at the input station and conveyed inside the system to the main cutting station. In the main cutting station the blocks are divided into end products and any cutting residue. The end products and cutting residue are conveyed to the dispensing station of the system and dispensed there from the system.

The system is provided for the processing of wafer blocks. Wafer blocks are rectangular, dimensionally stable, plate-like structures having a sandwich structure in which wafer sheets and cream layers are arranged alternately one above the other. The uppermost layer of the sandwich structure can be a wafer sheet or a cream layer. The wafer sheets are flat baked wafer sheets or wafer sheets baked flat in sections which are provided in the upper and lower side with a wafer pattern and have a crispy-brittle consistency. The cream layers contain mostly a cream whipped with air. Instead of the cream layers, other filling mass layers can also be contained in the wafer blocks. In hollow wafer blocks the wafer sheets or the outer wafer sheet in each case can be curved outwards in sections from the plane of the wafer sheet whereby, for example, cream-filled hollow wafers can be produced.

FIGS. 1 and 2 show schematically a system 1 according to the invention in in-line design. The system 1 provides a rectilinear transport path. Along this an input station 2, a main cutting station 3 and a dispensing station 4 are disposed consecutively in a line. The input station 2 and the dispensing station 4 are only shown schematically in FIGS. 1 and 2.

In the system 1 a horizontal contact plate 5 is provided, which is disposed on the underside of the transport path and extends from the input station 2 right into the main cutting station 3. A main conveying device 6 is provided in the system 1, which is located above the contact plate 5 and extends along the transport path from the input station 2 into the main cutting station 3. The main conveying station 6 conveys the blocks lying on the contact plate 5 from the conveying station 2 into the main cutting station 3.

The main conveying device 6 is provided with pressure plates 7 disposed transversely to the longitudinal direction of the system. The pressure plates 7 are fastened to two endless chains 8, 9 extending in the longitudinal direction of the system, in which in each case the horizontal lower chain run is disposed above the contact plate 5. The pressure plates 7 are each pivotable about a horizontal axis from an oblique rest position into a horizontal working position. The pressure plates 7 pivoted into their vertical working position are moved forwards in the longitudinal direction of the system by the lower chain run of the two endless chains 8, 9. Here each pressure plate 7 grips a block (B) lying on the contact plate 5 on the rear side and pushes the block (B) to the front end of the contact plate 5.

The guide strips 10, 11 which delimit the transport path laterally are disposed above the contact plate 5 at the front end of the contact plate 5. FIG. 3 shows a block (B) lying on the contact plate 5 between the two guide strips 10, 11.

A contour cutting apparatus 12 which is disposed transversely to the transport path is disposed in the main cutting station 3. The contour cutting apparatus 12 is disposed after the contact plate 5. This provides a contour cutting module 13 which has a contour cutting frame 14 which is displaceable in the transverse direction of the system which contains at least one vertically disposed cutting wire 14a. The contour cutting frame 14 is moved to and fro in the transverse direction of the system by the contour cutting module 13 whilst a block is conveyed by the main conveying device 6 through the contour cutting apparatus 12 in the longitudinal direction of the system. The cutting wire 14a produces a contour cut in the forward-moving block in which the longitudinal movements of the block are combined with the transverse movements of the contour cutting frame 14. The combination of the two movements determines the profile of the contour cut produced by the cutting wire 14a.

On passing through the contour cutting apparatus 12, the blocks (B) are divided by the contour cuts produced by the cutting wire 14a of the contour cutting module 13. In this case, the desired end products and any cutting residue are produced. Both then emerge on the front side of the contour cutting apparatus 12. The end products have an outline produced by the contour cuts.

Located downstream of the contour cutting apparatus 12 is an endless conveyor belt 15 which receives the end products and removes them from the system 1. The conveyor belt 15 extends along the transport path into the dispensing station 4. The conveyor belt 15 has a rear end located directly after the contour cutting apparatus 12 which is provided with a blade edge deflection which is formed by a thin deflecting roller 16. At the rear end of the conveyor belt 15 guide strips 17, 18 which delimit the transport path laterally are located above the conveyor belt 15. FIG. 4 shows a block lying on the conveyor belt 15 between the guide strips 17, 18. The block has passed the contour cutting apparatus 12 and is already cut.

FIG. 5 shows a further system 20 according to the invention in in-line design.

This comprises an input station 21, a stacking station 22, a first cutting station 23, a main cutting station 24 and a dispensing station 25. The stations are arranged consecutively in a line in the longitudinal direction of the system.

The blocks are supplied to the system 20 in the input station 21. A feed device 26 extends in the longitudinal direction of the system from the input station 21 through the stacking station 22 as far as the horizontal contact plate 27 which extends in the longitudinal direction of the system through the first cutting station 23 into the main cutting station 24. The feed device 26 has adjacently disposed transport belts 28 which extend in the longitudinal direction of the system from the input station 21 through the stacking station 22 as far as the horizontal contact plate 27. The contact plate 27 is attached to the upper side of the machine frame 29 which is supported by means of feet 30 on the ground 31. In the rear half, the contact plate 27 is provided with longitudinal slots in which the front end sections 28a of the transport belt 28 are received. The feed device 26 conveys the blocks from the input station 21 through the stacking station 22 to the contact plate 27. The blocks are placed on the rear half of the contact plate 27 by lowering the front end sections 28a of the transport belt 28.

In the stacking station 23 two or three blocks can be stacked one above the other to form a block stack. The block stack is placed on the transport belt 28. The blocks or block stacks lie on the transport belt 28 at a distance one behind the other. The blocks or block stacks are conveyed by the transport belts 28 of the feed device 26 to the contact plate 27 and placed on the rear half of the contact plate 27.

The system 20 has a main conveying device 32 which is disposed above the contact plate 27 and which extends in the longitudinal direction of the system into the main cutting station 24. Two endless transport chains 34 are disposed adjacent to one another in the supporting frame 33 of the main conveying device 32 in which the horizontal lower chain runs are located above the contact plate 27. Pressure plates 35 disposed transversely to the longitudinal direction of the system are attached to the transport chains 34. The pressure plates 35 are disposed at a distance one behind the other and are pivotable from an oblique rest position into a vertical working position. The transport chains 34 convey the pressure plates 35 pivoted into their vertical working position along the upper side of the contact plate 27 forwards in the longitudinal direction of the system. Each pressure plate 35 grasps a block or block stack lying on the contact plate 27 on its rear side and pushes this in the longitudinal direction of the system forwards to the front end of the contact plate 27.

An elongated beam 36 is located below the supporting frame 33 of the main conveying device 32, which extends in the longitudinal direction of the system into the main cutting station 24. The beam 36 serves as a hold-down device for the blocks or block stacks lying on the contact plate 27. The distance of the beam 36 from the contact plate 27 is adjustable. The beam 36 prevents tilting of the blocks or block stacks lying on the contact plate 27 whilst these are pushed forwards by the main conveying device 32 on the contact plate 27.

The first cutting station 23 of the system 20 is disposed in the region of the front half of the contact plate 27. The first cutting station 23 provides a cutting apparatus 37 located underneath the contact plate 27 which has cutting blades 38 circulating in the transverse direction of the system which during the cutting process project upwards through transverse slots 39 located in the contact plate 27 and cut the blocks or block stacks lying on the contact plate 27. The cutting blades 38 are fastened to two endless chains 40 which circulate in the transverse direction of the system. The cutting blades 38 are raised from the circulating chains 40 before the cutting process through the transverse slots 39 above the contact plate 28 and after the cutting process are lowered below the contact plate 28. The cutting blades 38 produce straight cuts in the blocks or block stacks lying on the contact plate 27, which extend in the transverse direction of the system. The straight cuts cut the blocks or block stacks into strips or strip stacks which are disposed one behind the other in the longitudinal direction of the system.

The main cutting station 24 is located downstream of the first cutting station 23. In the main cutting station 24 a contour cutting apparatus 41 is provided which cuts the strips or strip stacks with the contour cuts produced by it whilst these are pushed by the main conveying device 32 in the longitudinal direction of the system through the contour cutting apparatus 41. The contour cutting apparatus 41 is disposed transversely to the transport path. This provides a contour cutting module in which at least one vertically disposed cutting wire is disposed in a contour cutting frame which can be moved in the transverse direction of the system, which is moved to and fro by the contour cutting module to produce the contour cuts in the transverse direction of the system. The contour cuts cut the strips or the strip stacks into the end products. The end products emerge at the front side of the contour cutting apparatus 41. Located downstream of the contour cutting apparatus 41 is a conveyor belt 42 which removes the end products from the system 20. The conveyor belt 42 extends into the dispensing station 25. This has a rear end disposed directly after the contour cutting apparatus 41 which is provided with a blade edge deflection formed by a thin deflecting roller 43. The main cutting station 24 substantially corresponds to the main cutting station 3 of the system 1 from FIGS. 1 and 2.

FIGS. 6 to 10 show another system 45 according to the invention. FIG. 6 shows the system 45 in plan view.

The system 45 provides an input station 46 which is followed by a conveyor belt 47 extending in the longitudinal direction of the system, which conveys the blocks into the interior of the system 45. A main cutting station 48 in which the blocks are cut and the end products are produced in provided in the interior of the system 45. The end product are transferred to a dispensing device 49. The dispensing device 49 extends in the transverse direction of the system from the main cutting station 48 to the dispensing station 50. The dispensing station 50 is disposed at the front edge of the system 45 in FIG. 6.

The main cutting station 48 provides a rectilinear transport path for the blocks. The transport path extends in the longitudinal direction of the system. A contour cutting apparatus 51 which cuts the blocks through contour cuts is disposed on the transport path. The contour cutting apparatus 51 is disposed transversely to the transport path of the blocks. Located upstream of the contour cutting apparatus 51 in the longitudinal direction of the system is a rear contact plate 52 and located downstream in the longitudinal direction of the system is a front contact plate 53.

The contour cutting apparatus 51 comprises two contour cutting modules 51a, 51b disposed consecutively in the longitudinal direction of the system comprising contour cutting frames 54, 55 which are displaceable in the transverse direction of the system. The rear contour cutting module 51a is located adjacent to the front edge of the rear contact plate 52 and provides a rear contour cutting frame 54, which is disposed near the rear side of the contour cutting apparatus 51. The front contour cutting module 51b is located adjacent to the rear edge of the front contact plate 53 and provides a front contour cutting frame 55 which is located near the front side of the contour cutting apparatus 51. In both contour cutting modules 51a, 51b the contour cutting frame 54, 55 is connected to a drive module 56, 57 which moves the contour cutting frame 54, 55 to and fro in the transverse direction of the system. The drive module 56, 57 contains a movement device which is coupled to a drive motor and moves the contour cutting frame 54, 55 to and fro in the transverse direction of the system. FIG. 7 shows an embodiment of the drive modules 56, 57.

In the rear contour cutting module 51a the rear contour cutting frame 54 is connected to a drive module 56 located underneath said frame. The drive module 56 provides a horizontal recirculating ball screw drive 56a extending in the transverse direction of the system in which the nut of the recirculating ball screw is connected rigidly to the rear contour cutting frame 54. The recirculating ball screw is driven by a drive motor 56b via a toothed belt drive 56c. The recirculating ball screw is turned clockwise or anticlockwise by the drive motor 56b in order to displace the rear contour cutting frame 54 in the transverse direction of the system from left to right or from right to left.

In the contour cutting module 51a a chain drive disposed in the transverse direction of the system can be provided below the rear contour cutting frame 54, in which the endless chain circulating in the transverse direction of the system is coupled mechanically to the rear contour cutting frame 54. The chain drive is driven by a drive motor. The endless chain of the chain drive is moved forwards and backwards in the transverse direction of the system in order to move the contour cutting frame 54 in the transverse direction of the system from left to right and from right to left.

In the front contour cutting module 51b the front contour cutting frame 55 is connected to a drive module 57 located underneath said frame. The drive module 57 provides a horizontal recirculating ball screw drive 57a extending in the transverse direction of the system in which the recirculating ball screw nut is connected rigidly to the front contour cutting frame 55. The recirculating ball screw is driven by a drive motor 57b via a toothed belt drive 57c. The recirculating ball screw is turned by the drive motor 57b in the clockwise or anticlockwise direction in order to displace the front contour cutting frame 55 in the transverse direction of the system from left to right or from right to left.

In the front contour cutting module 51b a chain drive disposed in the transverse direction of the system can be provided below the front contour cutting frame 55, in which the endless chain circulating in the transverse direction of the system is coupled mechanically to the front contour cutting frame 55. The chain drive is driven by a drive motor. The endless chain of the chain drive is moved forwards and backwards in the transverse direction of the system in order to move the front contour cutting frame 55 in the transverse direction of the system from left to right or from right to left.

In the main cutting station 48, a main conveying device 58 is provided for the blocks. The main conveying device provides a transport unit 58a mounted upstream of the contour cutting apparatus 51. The transport unit 58a is provided with a rear block slider 59 which is displaceable along the transport path of the blocks in the longitudinal direction of the system. The block slider 59 is displaceable along the transport path of the blocks from a rear end position into a front end position. In the rear end position the block slider 59 is mounted upstream of the rear contact plate 52. The block slider 59 is pushed by the transport unit 58a from the rear end position forwards beyond the rear contact plate 52 into the front end position. As a result, a block lying on the rear contact plate 52 is pushed forwards along the transport path of the blocks in the longitudinal direction of the system. The block is pushed along the transport path of the blocks through the contour cutting apparatus 51 onto the front contact plate 53.

The block slider 59 of the transport unit 58a is connected to a drive module 60 which produces the longitudinal movements of the block slider 59. The drive module 60 is located underneath the transport path of the blocks. The drive module 60 provides a horizontal recirculating ball screw drive 61 extending in the longitudinal direction of the system. The recirculating ball screw drive 61 comprises a recirculating ball screw 61a and a recirculating ball screw nut 61b. The block slider 59 of the transport unit 58a is rigidly connected to the recirculating ball screw nut 61b. The recirculating ball screw 61a is driven at the rear end by a drive motor 62 which is coupled to the recirculating ball screw 61a via a toothed belt drive 63. The recirculating ball screw 61a is turned by the drive motor 62 in the clockwise or in the anticlockwise direction in order to move the block slider 59 forwards or backwards in the longitudinal direction of the system.

The block slider 59 of the transport unit 58a can be attached to a carriage which has rails running in the longitudinal direction of the system and is displaceable along these rails in the longitudinal direction of the system. A chain drive can be provided as the drive module for the block slider 59 which is disposed in the longitudinal direction of the system and has an endless chain circulating in the longitudinal direction of the system which is coupled mechanically to the carriage. The chain drive is driven by a drive motor. The endless chain of the chain drive is moved forwards and backwards in the longitudinal direction of the system in order to move the block slider 59 of the transport unit 58 forwards and backwards in the longitudinal direction of the system.

The blocks are supplied to the system 45 at the input station 46 and there placed on the conveyor belt 47.

The conveyor belt 47 conveys the blocks into the interior of the system 45. A contact plate 64 for the blocks is located at the front end of the conveyor belt 47. The contact plate 64 is assigned a transverse slider 65. The transverse slider 65 is displaceable along the contact plate 64 in the transverse direction of the system. The transverse slider 65 is moved to and fro in the transverse direction of the system by a drive cylinder 71.

The blocks lying on the contact plate 64 are pushed by the transverse slider 65 in the transverse direction of the system onto the rear contact plate 52 of the main cutting station 48.

In the main cutting station 48 the blocks are pushed by the block slider 59 of the transport unit 58a along the transport path of the blocks in the longitudinal direction of the system through the contour cutting apparatus 51. The blocks pass through the two contour cutting modules of the contour cutting apparatus 51 whilst in these the contour cutting frames 54, 55 are moved to and fro by the drive modules 56, 57 in the transverse direction of the system. The rear contour cutting module 51a produces with the rear contour cutting frame 54 a first batch of contour cuts in which the profile is produced by the combination of the longitudinal movements of the blocks with the transverse movements of the rear contour cutting frame 54. The front contour cutting module 51b produces with the front contour cutting frame 55 a second batch of contour cuts in which the profile is produced by the combination of the longitudinal movements of the blocks with the transverse movements of the front contour cutting frame 55. The two batches of contour cuts contain mutually opposite subsections which complement one another to form a complete outline of the end products to be produced.

FIG. 26 shows an example for a rectangular block cut by two batches of contour cuts in which the mutually opposite subsections of the two batches of contour cuts complement one another to form complete circles. The one batch of contour cuts is shown by solid lines and the second batch of contour cuts is shown by dashed lines. The block contains 15 end products configured as circular disks which are disposed in three longitudinal rows in the block. The block contains the residues remaining during cutting of the block, that is the two edge strips and the two remaining pieces located between the three longitudinal rows of end products.

During passage through the two contour cutting modules, the blocks are cut into end products and block residue by the two batches of contour cuts produced by the contour cutting modules. The end products and block residue emerge at the front side of the contour cutting apparatus 51 in the longitudinal direction of the system 45 and are received by the front contact plate 53 of the main cutting station 48.

FIG. 8 shows a longitudinal section through the main cutting station 48. FIG. 8 shows a block (B) passing through the contour cutting apparatus 51. The block (B) lies on the rear contact plate 52 of the main cutting station 48. The block is pushed by the block slider 59 of the transport unit 58a in the longitudinal direction of the system through the contour cutting apparatus 51. A front section of the block (B) has already passed the contour cutting frames 54, 55 of the two contour cutting modules 51a, 51b and lies on the front contact plate 53 of the main cutting station 48.

In the main cutting station 48 an upper plate 66 is disposed above the rear contact plate 52. This serves as a hold-down device for the blocks lying on the rear contact plate 52. The distance of the upper plate 66 from the rear contact plate 52 is adjustable. The upper plate 66 prevents tipping of the blocks lying on the rear contact plate 52 whilst these are pushed through the contour cutting apparatus 51 by the block slider 59 of the transport unit 58.

Located above the rear contact plate 52 are the guide strips 67 which laterally delimit the transport path of the blocks. FIG. 10 shows a block lying on the rear contact plate 52 between the two guide strips 67 in a vertical section along the line B-B in FIG. 8.

In the main cutting station 48 an upper plate 68 is disposed above the front contact plate 53. This serves as a hold-down device for the cut blocks emerging from the contour cutting apparatus 51. The distance of the upper plate 68 from the front contact plate 53 is adjustable. The upper plate 68 prevents tipping of the cut blocks emerging from the contour cutting apparatus 51. Located above the front contact plate 53 are the guide strips 69 which laterally delimit the transport path of the blocks. FIG. 9 shows a cut block lying on the front contact plate 53 between the two guide strips 69 in a vertical section according to the line A-A in FIG. 8.

In the main cutting station 48 a transverse slider 70 is provided at the front contact plate 53 which pushes out from the main cutting station 48 the end products and block residue received by the front contact plate 53 in the transverse direction of the system. The transverse slider 70 is moved to and fro by a working cylinder 71 along the front contact plate 53 in the transverse direction of the system. The front contact plate 53 of the main cutting station 48 is followed in the transverse direction of the system by the dispensing device 49 which extends into the dispensing station 50. In the dispensing device 49 a horizontal contact plate 72 is provided for the cut blocks. The transverse slider 70 pushes one cut block after the other onto the contact plate 72. Each cut block pushes the cut block lying in front of it on the contact plate 72 further in the transverse direction of the system. Located along the contact plate 72 are lateral guide strips 73 along which the cut blocks slide. Instead of the contact plate 72 a conveyor belt can be provided which extends in the transverse direction of the system and conveys the cut blocks to the dispensing station 50.

FIGS. 11-18 show a further system 75 according to the invention. FIG. 11 shows the system 75 in plan view. The system 75 comprises an input station 76, a main cutting station 77 and a dispensing station 78. The input station 76 is disposed at the right-hand edge of the system 75 in FIG. 11. The main cutting station 77 is disposed in the interior of the system 75. The dispensing station 78 is disposed at the front edge of the system 75 in FIG. 11.

From the input station 76 a conveyor belt 79 running in the longitudinal direction of the system leads into the interior of the system 75. Located at the front end of the conveyor belt 79 is a contact plate 80 for the blocks. A transverse slider 81 is assigned to the contact plate 80. The transverse slider 81 is displaceable along the contact plate 80 in the transverse direction of the system. The transverse slider 81 is moved to and fro in the transverse direction of the system by a working cylinder 82. The blocks are conveyed by the conveyor belt 79 in the longitudinal direction of the system to the contact plate 80 and fed by the transverse slider 81 in the transverse direction of the system to the main cutting station 77.

In the main cutting station 77, a rear contact plate 83, a contour cutting apparatus 84 and a front contact plate 85 are disposed consecutively in a line in the longitudinal direction of the system. A rectilinear transport path for the blocks is provided in the main cutting station 77. The transport path extends in the longitudinal direction of the system from the rear contact plate 83 through the contour cutting apparatus 84 to the front contact plate 85. The contour cutting apparatus 84 is located between the rear contact plate 83 and the front contact plate 85. The contour cutting apparatus 84 is disposed transversely to the transport path. The contour cutting apparatus 84 contains two contour cutting modules 86, 87. These are disposed consecutively in the longitudinal direction of the system and are provided with cutting tools displaceable in the transverse direction of the system. Each contour cutting module 86, 87 contains a contour cutting frame 86a, 87a which is displaceable in the transverse direction of the system and a drive module 86c, 87c connected to this, which produces the transverse movements of the contour cutting frame 86a, 87a. Each contour cutting frame 86a, 87a contains at least one vertical cutting wire 86b, 87b (FIGS. 17 and 18).

A main conveying device 88 for the blocks is provided in the main cutting station 77. The main conveying device 88 extends in the longitudinal direction of the system and comprises a first transport unit 88a which moves the blocks forwards and a second transport unit 88b which moves the blocks backwards.

The first transport unit 88a is mounted upstream of the rear contact plate 83 in the longitudinal direction of the system. The first transport unit 88a provides a rear block slider 89 which is movable to and fro along the rear contact plate 83 in the longitudinal direction of the system. The first transport unit 88a provides a drive module 90 connected to the rear block slider 89 which produces the longitudinal movements of the rear block slider 89. The drive module 90 is located below the rectilinear transport path. The drive module 90 provides a recirculating ball screw drive 91 located in the longitudinal direction of the system. The recirculating ball screw drive 91 comprises a recirculating ball screw 91a and a recirculating ball screw nut 91b. The block slider 89 of the first transport unit 88a is rigidly connected to the recirculating ball screw nut 91b. The recirculating ball screw 91a is driven at the rear end by a drive motor 92 which is coupled to the recirculating ball screw 91a via a toothed belt drive 93. The recirculating ball screw 91a is turned by the drive motor 92 in the clockwise direction or in the anticlockwise direction in order to move the block slider 89 forwards and backwards in the longitudinal direction of the system.

The second transport unit 88b is located downstream of the front contact plate 85 in the longitudinal direction of the system. The second transport unit 88b provides a front block slider 94 which is movable to and fro along the front contact plate 85 in the longitudinal direction of the system. The second transport unit 88b provides a drive module 95 connected to the front block slider 94 which produces the longitudinal movements of the front block slider 94. The drive module 95 is located underneath the rectilinear transport path. The drive module 95 provides a recirculating ball screw drive 96 disposed in the longitudinal direction of the system. The recirculating ball screw drive 96 comprises a recirculating ball screw 96a and a recirculating ball screw nut 96b. The block slider 94 of the second transport unit 88 is rigidly connected to the recirculating ball screw nut 96b. The recirculating ball screw 96a is driven at the rear end by a drive motor 97 which is coupled to the recirculating ball screw 96a via a toothed belt drive 98. The recirculating ball screw 96a is turned by the drive motor 97 in the clockwise direction or in the anticlockwise direction in order to move the block slider 94 forwards or backwards in the longitudinal direction of the system.

In the system 75 the blocks are fed by the transverse slider 81 assigned to the contact plate 80 in the transverse direction of the system to the main cutting station 77 and pushed onto the rear contact plate 83 of the main cutting station 77.

In the main cutting station 77 the blocks lying on the rear contact plate 83 are gripped by the two transport units 88a, 88b of the main conveying device 88. The two transport units 88a, 88b push the blocks along the rectilinear transport path into the contour cutting apparatus 84 and through this onto the front contact plate 85 of the main cutting station 77. Whilst the blocks pass through the contour cutting apparatus 84, the two contour cutting modules 86, 87 in this are actuated. The two contour cutting modules 86, 87 move their contour cutting frames 86a, 87a provided with cutting wires 86b, 87b independently of one another to and fro in the transverse direction of the system. At the same time the blocks are moved only forwards or forwards and backwards in the longitudinal direction of the system by the two transport units 88a, 88b.

The rear contour cutting module 86 produces contour cuts in the blocks whose profile is obtained from the combination of the transverse movements of the contour cutting frame 86a of the rear contour cutting module 86 with the longitudinal movements of the blocks. The contour cuts produced by the front contour cutting module 87 in the blocks have a different profile. This is obtained from the combination of the transverse movements produced by the contour cutting frame 87a of the front contour cutting module 87 with the longitudinal movements of the blocks. The contour cuts produced by the two contour cutting modules 86, 87 each contain subsections adapted to the outlines of the end products to be produced. Mutually opposite subsections of the two contour cuts complement each other to form the outline of an end product.

The two contour cutting modules 86, 87 with their cutting wires 86b, 87b moved to and fro in the transverse direction of the system produce two differently running contour cuts in the blocks moved only forwards by the transport units 88a, 88b in the longitudinal direction of the system, in which there is no subsection which has a backward-running contour contrary to the direction of advance of the blocks.

The two contour cutting modules 86, 87 with their cutting wires 86b, 87b moved to and fro in the transverse direction of the system produce two differently running contour cuts in the blocks moved forwards and backwards by the transport units 88a, 88b in the longitudinal direction of the system, in which there is at least one subsection which has a backward-running contour contrary to the direction of advance of the blocks. The contour cuts produced by the contour cutting modules 86, 87 in the forward- and backward-moving blocks can also have two or more subsections which have a backward-running contour contrary to the direction of advance of the blocks. The two contour cutting modules 86, 87 can produce contour cuts in the forward and backward moving blocks which with their subsections are adapted to the irregular outline of a four-leaved clover leaf where the rear contour cutting module 86 produces a contour cut whose profile corresponds to the irregular outline of the left clover leaf half and the front contour cutting module 87 produces a contour cut whose profile corresponds to the irregular outline of the right clover leaf half.

In the main cutting station 77 the cut blocks emerging from the contour cutting apparatus 84 on the front side are received by the front contact plate 85. The front contact plate 85 is assigned a transverse slider 99 which is moved to and fro by a working cylinder 100 along the front contact plate 85 in the transverse direction of the system. The cut blocks lying on the front contact plate 85 are pushed by the transverse slider 99 out from the main cutting station 77 in the transverse direction of the system. The front contact plate 85 of the main cutting station 77 is followed in the transfer direction of the system by a dispensing device 101 which extends into the dispensing station 78. In the dispensing device 101 a horizontal contact plate 102 is provided for the cut blocks. The transverse slider 99 pushes one cut block after the other onto the contact plate 102. Each cut block pushes the cut block located in front of it on the contact plate 102 further in the transverse direction of the system. Lateral strips 103 are disposed along the contact plate 102 along which the cut blocks slide. Instead of the contact plate 102 a conveyor belt can be provided which extends in the transverse direction of the system and conveys the cut blocks to the dispensing station 78.

FIG. 12 shows the main conveying device 88 and the contour cutting apparatus 84 of the main cutting station 77 of the system 75. The contour cutting apparatus 84 is shown at the centre of FIG. 12. The rear contour cutting module 86 is shown on the right in FIG. 12 and the front contour cutting module 87 is shown on the left in FIG. 12. Of the rear contour cutting module 86, FIG. 12 shows the contour cutting frame 86a disposed transversely to the transport path of the blocks and the drive module 86c which produces the transverse movements of the contour cutting frame 86a. The drive module 86c has the same structure as the drive module 56 which is provided in the rear contour cutting module of the contour cutting apparatus 51 of the system 45. Of the front contour cutting module 87 FIG. 12 shows the contour cutting frame 87a disposed transversely to the transport path of the blocks and the drive module 87c which produces the transverse movements of the contour cutting frame 87a. The drive module 87c has the same structure as the drive module 57 which is provided in the front contour cutting module of the contour cutting apparatus 51 of the system 45.

FIG. 12 shows the two transport units 88a and 88b of the main conveying device 88 disposed along the transport path of the blocks. The first transport unit 88a located upstream of the contour cutting apparatus 84 is shown on the right in FIG. 12. The second transport unit 88b located downstream of the contour cutting apparatus 84 is shown on the left in FIG. 12. Of the first transport unit 88a, FIG. 12 shows the rear block slider 89 and the drive module 90 with the recirculating ball screw drive 91 located in the longitudinal direction of the system 45 together with the drive motor 92. Of the second transport unit 88b, FIG. 12 shows the front block slider 94 and the drive module 95 with the recirculating ball screw drive 96 located in the longitudinal direction of the system together with the drive motor 97.

FIG. 13 shows a longitudinal section through the main cutting station 77. FIG. 13 shows a block (B) pushed a little way into the contour cutting apparatus 84. The block (B) lies with its larger part on the rear contact plate 83 and in front of the rear block slider 89 of the first transport unit 88a. A small, already-cut part of the block (B) lies on the front contact plate 85 and in front of the front block slider 94 of the second transport unit 88b.

An upper plate 83a is disposed above the rear contact plate 83. This serves as a hold down device for the block lying on the rear contact plate 83. Guide strips 83b which laterally delimit the transport path of the blocks are located above the rear contact plate 83. FIG. 14 shows a block lying on the rear contact plate 83 between the two guide strips 83b in a vertical section according to the line A-A in FIG. 13.

An upper plate 85a is disposed above the front contact plate 85. This serves as a hold-down device for the cut blocks emerging from the contour cutting apparatus 84. Guide strips 85b which laterally delimit the transport path of the blocks are located above the front contact plate 85. FIG. 15 shows a cut block lying on the front contact plate 85 between the two guide strips 85b in a vertical section along the line B-B in FIG. 13.

FIG. 16 shows an oblique view of the system 75 without the upper plate 83a disposed above the rear contact plate 83 and without the upper plate 85a disposed above the front contact plate 85. FIG. 16 shows the vertical walls 104 disposed along the rear side of the system 75 which delimit the interior of the system 75 towards the outside. The control cabinet 105 belonging to the system 75 is shown on the left edge of the system 75 in FIG. 16.

FIGS. 17 and 18 show the contour cutting modules 87 of the contour cutting apparatus 84.

FIG. 17 shows the front contour cutting module 87 with the contour cutting frame 87a displaceable in the transverse direction of the system and the drive module 87c which produces the transverse movements of the contour cutting frame 87a. FIG. 17 shows the contour cutting frame 87a in its left end position. The contour cutting frame 87a contains an elongated rectangular window. In the left half of the window four vertical cutting wires 87b are arranged adjacently at a distance from one another. The right half of the window is free from cutting wires and is used for unhindered passage of the blocks. The drive module 87c is provided with a recirculating ball screw drive driven by a drive motor 87d via a toothed belt drive 87e, which extends in the transverse direction of the system and of which the recirculating ball screw nut is rigidly connected to the contour cutting frame 87a. In FIG. 17 of the drive module 87c only the components disposed at the right end of the front contour cutting module 87, drive motor 87d and toothed belt drive 87e can be seen.

FIG. 18 shows the rear contour cutting module 86 with the contour cutting frame 86a displaceable in the transverse direction of the system and the drive module 86c which produces the transverse movements of the contour cutting frame 86a. FIG. 18 shows the contour cutting frame 86a in its right end position. The contour cutting frame 86a contains an elongated rectangular window. In the left half of the window four vertical cutting wires 86b are arranged adjacently at a distance from one another. The right half of the window is free from cutting wires and is used for unhindered passage of the blocks. The drive module 86c is provided with a recirculating ball screw drive driven by a drive motor 86d via a toothed belt drive 86e, which extends in the transverse direction of the system and of which the recirculating ball screw nut is rigidly connected to the contour cutting frame 86a. In FIG. 18, of the drive module 86c only the components disposed at the right end of the front contour cutting module 86, drive motor 86d and toothed belt drive 86e can be seen.

FIG. 19 shows another system 106 according to the invention in a plan view. In the system 106 the end products are cut out from the blocks with a single contour cut.

The system 106 provides an input station 107 disposed at the edge of the system 106 and a main cutting station 108 disposed in the interior of the system 106.

In the main cutting station 108, a rear contact plate 109, a contour cutting apparatus 110 and a front contact plate 111 are disposed consecutively along a rectilinear transport path in the longitudinal direction of the system 106. The contour cutting apparatus 110 is disposed transversely to the transport path. The contour cutting apparatus 110 contains at least one contour cutting module which has at least one cutting tool and moves this to and fro in the transverse direction of the system. A main conveying device 112 is disposed along the transport path. This provides a first transport unit 113 mounted upstream of the contour cutting apparatus 110 and a second transport unit 114 mounted downstream of the contour cutting apparatus 110. The blocks are moved to and fro in the main cutting station 108 in the longitudinal direction of the system by the two transport units 113 and 114 whereas the contour cutting module of the contour cutting apparatus 110 moves its cutting tool to and fro in the transverse direction of the system.

The contour cutting apparatus 110 produces only a single contour cut in each block. One half of the contour cut is produced during the forward movement of the block and the other half is produced during the backward movement of the block. The block is pushed from the rear contact plate 109 forwards onto the front contact plate 111 and from the front contact plate 111 backwards onto the rear contact plate 109. To produce a contour cut which corresponds to the circumference of a circular disk, the block is moved only once forwards and once backwards. To produce a contour cut which corresponds to the irregular circumference of a four-leaved clover leaf, the block is moved repeatedly forwards and backwards during the production of the first half of the contour cut and likewise during the production of the second half of the contour cut.

After execution of the contour cut, the cut block together with the end product lies on the rear contact plate 109. A dispensing device 115 adjoining the rear contact plate 109 in the transverse direction of the system is provided in the system 106, which extends into the dispensing station 116 and conveys the cut blocks together with the end products from the main cutting station 108 to the dispensing station 116.

The contour cutting module of the contour cutting apparatus 110 can also have three or four cutting wires disposed adjacently at a distance from one another in the transverse direction of the system, which are moved to and fro by the contour cutting module in the transverse direction of the system whilst the blocks are moved forwards and backwards by the transport units 113, 114 along the rectilinear transport path. In this way, three or four end products configured as flat plates and disposed adjacent to one another in the transverse direction of the system are formed. The cut blocks which each contain three or four end products disposed adjacent to one another in the transverse direction of the system lie on the rear contact plate 109 and are removed from there in the transverse direction of the system.

FIG. 20 shows in a plan view another system 117 according to the invention. The input station 118 and the dispensing station 119 are disposed on mutually opposite side edges of the system 117. The main cutting station 120 is disposed in the interior of the system 117. The main cutting station 120 corresponds in its constructive structure to the main cutting station 48 of the system 45 (FIGS. 6-10).

In the system 117 the blocks are supplied to the main cutting station 120 in the transverse direction of the system. A conveyor belt 121 leads from the input station 118 in the transverse direction of the system into the interior of the system to the main cutting station 120. The conveyor belt 121 pushes the blocks in the transverse direction of the system onto the rear contact plate 120a of the main cutting station 120. In the main cutting station 120 the blocks are pushed by the block slider 122 of the main conveying device in the longitudinal direction of the system through the contour cutting apparatus 123 of the main cutting station 120 as far as the front contact plate 124 of the main cutting station 120. During passage through the contour cutting apparatus 123 the blocks are cut by the contour cuts produced by the contour cutting apparatus 123. The cutting products and cutting residue thereby produced are received as cut blocks by the front contact plate 124.

In the system 117 a dispensing device 125 adjoining the front contact plate 124 of the main cutting station 120 in the transverse direction of the system is provided for the cut blocks. The dispensing device 125 extends in the transverse direction of the system into the dispensing station 119. The dispensing device 125 corresponds in its constructive structure to the dispensing device 49 of the system 45 (FIGS. 6-10).

FIG. 21 shows a further system 126 according to the invention in plan view. The system 126 comprises an input station 127 disposed on the left side edge, a first cutting station 128 extending in the transverse direction of the system, a main cutting station 129 extending in the longitudinal direction of the system and a dispensing station 130 disposed on the right side edge.

The input station 127 is disposed adjacent to the first cutting station 128. This provides a rectilinear first transport path. The first transport path extends in the transverse direction of the system. A conveying device for the blocks is disposed in the first cutting station 128. The conveying device provides a transport unit which has a first block slider 131 which is displaceable along the first transport path. For better clarity only the first block slider 131 of the conveying device is shown in FIG. 21. FIG. 21 shows the first block slider 131 in its rear end position and in its front working position.

The first block slider 131 pushes the blocks along the first transport path through a first cutting apparatus 132 disposed transversely to the first transport path. The first cutting apparatus 132 contains a stationary first cutting frame 133 which is disposed transversely to the first transport path and contains ten cutting wires which are disposed at a distance adjacent to one another. The first cutting frame 133 cuts the blocks (B) advanced along the first transport path into nine adjacently disposed strips (L). The first cutting frame 133 produces rectilinear cuts which extend in the transverse direction of the system. The blocks (B) cut into strips (L) are pushed out from the first cutting station 128 in the transverse direction of the system and pushed into the main cutting station 129.

The main cutting station 129 provides a rectilinear second transport path. The second transport path extends in the longitudinal direction of the system 126. A main conveying device is provided in the main cutting station 129, which has a second block slider 134 which is displaceable along the second transport path. For better clarity FIG. 21 only shows the second block slider 134 of the main conveying device. FIG. 21 shows the second block slider 134 in its rear end position and in its front working position.

The second block slider 134 pushes the blocks cut into strips (L) along the second transport path through a contour cutting apparatus 135 which is disposed transversely to the second transport path. The contour cutting apparatus 135 provides a contour cutting module 136 which has cutting tools which are movable to and fro transversely to the second transport path, which produce contour cuts in the strips (L) whose profile is formed from the combination of forward movements of the strips (L) with the transverse movements of the cutting tools of the contour cutting module 136. The strips (L) are cut by the contour cuts produced by the contour cutting module 136. The desired end products are thereby produced. These are received by a contact plate 137 located downstream of a contour cutting apparatus 135. The contact plate 137 extends along the second transport path into the dispensing station 130. Instead of the contact plate 137, an endless conveyor belt can also be provided which receives the end products and conveys them out from the system 126.

The contour cutting module 136 provides an elongated contour cutting frame 138 which is disposed transversely to the second transport path and contains eight cutting wires 139 which are disposed along the contour cutting frame 138 adjacently at a distance from one another. The contour cutting module 136 provides a drive module 140 which is connected to the contour cutting frame 138 and moves the contour cutting frame 138 to and fro transversely to the second transport path whilst the blocks cut into strips (L) are pushed along the second transport path through a contour cutting apparatus 135. The contour cutting frame 138 produces eight contour cuts in the strips (L) with its eight cutting wires 139. The profile of the contour cuts is formed by the combination of the forward movements of the strips (L) with the transverse movements of the contour cutting frame 138. FIG. 21 shows contour cuts with a wave-shaped profile. The relevant transverse movements of the contour cutting frame 138 are produced by the drive module 140 which is shown in enlarged scale in FIG. 22.

The drive module 140 provides a first assembly connected to the main conveying device and a second assembly disposed in the contour cutting apparatus 135.

The first assembly provides a rod 141 disposed along the second transport path which carries a contour template 142 projecting laterally from this rod. The contour template 142 is configured as a horizontally disposed flat plate which has a longitudinal edge 143 whose profile corresponds to the contour to be produced. Rod 141 and contour template 142 are disposed below the second transport path. The rod 141 is rigidly connected to the block slider 134 of the main conveying device and is moved by this to and fro in the longitudinal direction of the second transport path. The rod 141 and the contour template 142 extend in the longitudinal direction of the second transport path from the block slider 134 forwards as far as the contour cutting apparatus 135 and beyond this a little way in the longitudinal direction.

The second assembly provides a guide device for the rod 141 which is disposed in the frame 144 of the contour cutting apparatus 135. The guide device comprises guide rollers 145 disposed on both sides of the rod 141, which are disposed consecutively in the longitudinal direction of the second transport path and are rotatably mounted in the frame 144 of the contour cutting apparatus 135. The second assembly provides a roller 146 rotatably mounted on the contour cutting frame 138 which abuts against the contour template 142. The roller 146 is attached to the lower frame part 138a of the contour cutting frame 138 located underneath the second transport path. The contour cutting frame 138 is held by a spring not shown with the roller 146 in abutment against the contour template 142.

The contour cutting frame 138 is disposed transverse to the second transport path and is guided displaceably with its lower frame part 138a in the frame 144 of the contour cutting apparatus 135 transversely to the second transport path. The guide device for the contour cutting frame 138 comprises guide rollers 147 disposed on both sides of the lower frame part 138a, which are located at a distance from one another along the lower frame part 138a and which are rotatably mounted in the frame 144 of the contour cutting apparatus 135.

In the contour cutting module 136 the drive module 140 derives the transverse movements of the contour cutting frame 138 from the forward movement of the block slider 134 of the main conveying device. With the forward movement of the block slider 134 the rod 141 is pushed in the longitudinal direction of the second transport path through the guide device provided with guide rollers 145 which is located in the frame 144 of the contour cutting apparatus 135. The contour template 142 fixed to the rod 141 is pushed in the longitudinal direction of the second transport path along the roller 146 attached to the contour cutting frame 138. The roller 146 is moved to and fro in the transverse direction by the forward-moving contour template 142. With the roller 146 the entire contour cutting frame 138 with its cutting wires 139 is moved to and fro in the transverse direction. The transverse movements of the cutting wires 139 follow the profile of the contour template 142. The contour cuts produced by the cutting wires 139 in the strips (L) produce a contour which agrees with the contour of the contour template 142.

The drive module shown in FIG. 22 produces contour cuts having a wavy profile which is predefined by the contour template 142. In order to change the contour of the contour cuts, it is only necessary to replace the rod 141 with the contour template 142 for another rod with another contour template.

FIG. 23 shows a main cutting station 148 of another system according to the invention. The main cutting station 148 provides a rectilinear transport path for the blocks. Along the transport path a rear contact plate 149, a contour cutting apparatus 150 disposed transversely to the transport path and a front contact plate 151 are disposed consecutively. A block slider 152a of the main conveying device 152 pushes the blocks along the transport path from the rear contact plate 149 through the contour cutting apparatus 150 onto the front contact plate 151. The blocks consist of two halves arranged one behind the other. The contour cutting apparatus 150 provides five consecutively disposed cutting modules 153, 154, 155, 156 and 157. The five cutting modules produce five differently running cuts S1, S2, S3, S4 and S5 in the blocks passing through the contour cutting apparatus 150. The five cuts divide the two block halves into eight end products and eight edge pieces. The end products correspond to a circular tart divided into eight parts.

The first cutting module 153 produces a straight cut S1 in the two block halves, which is disposed parallel to the longitudinal direction of the transport path. The first cutting module 153 provides a stationary cutting frame located transversely to the transport path. The cutting frame contains a vertical cutting wire D1 located in the middle of the transport path.

The second cutting module 154 is configured as a contour cutting module. This provides a cutting frame located transversely to the transport path which is provided with a cutting wire D2. The cutting frame is moved from left to right transversely to the transport path by a drive module not shown in FIG. 23 whilst the two block halves are pushed in the longitudinal direction through the contour cutting apparatus 150. The cutting frame produces with its cutting wire D2 a contour cut S2 running obliquely from left to right in the two block halves.

The third cutting module 155 is configured as a contour cutting module. This provides a cutting frame located transversely to the transport path which is provided with one cutting wire D3. The cutting frame is moved from right to left transversely to the transport path by a drive module not shown in FIG. 23 whilst the two block halves are pushed in the longitudinal direction through the contour cutting apparatus 150. The cutting frame produces with its cutting wire D3 a contour cut S3 running obliquely from right to left in the two block halves.

The fourth cutting module 156 is configured as a contour cutting module. It provides a cutting frame disposed transversely to the transport path which is provided with a cutting wire D4. The cutting wire D4 is located in the middle of the transport path at the beginning of the contour cut. The cutting frame is pushed to the right transversely to the transport path on passing through the first block half by a drive module not shown in FIG. 23 and is pushed to the left transversely to the transport path on passing through the second block half. At the end of the contour cut the cutting wire D4 is again located in the middle of the transport path. The cutting frame produces with its cutting wire D4 a contour cut which corresponds to a semicircle and forms the left half of the circular outline in the circular tart.

The fifth cutting module 157 is configured as a contour cutting module. This provides a cutting frame disposed transversely to the transport path which is provided with a cutting wire D5. The cutting wire D5 is located in the middle of the transport path at the beginning of the contour cut. The cutting frame is pushed to the left transversely to the transport path on passing through the first block half by a drive module not shown in FIG. 23 and is pushed to the right transversely to the transport path on passing through the second block half. At the end of the contour cut the cutting wire D5 is again located in the middle of the transport path. The cutting frame produces with its cutting wire D5 a contour cut which corresponds to a semicircle and forms the right half of the circular outline in the circular tart.

FIG. 24 shows a further embodiment of the main cutting station 158. This provides a rectilinear transport path for the blocks. Located consecutively along the transport path are a rear contact plate 159, a contour cutting apparatus 160 and a front contact plate 161.

The contour cutting apparatus 160 is disposed transversely to the transport path and provides two contour cutting modules 162, 163 which are disposed consecutively along the transport path. The rear contour cutting module 162 has a contour cutting frame disposed transversely to the transport path with a vertically disposed cutting wire D2. The contour cutting frame is moved to and fro transversely to the transport path by a drive module not shown in FIG. 24 which is located below the contour cutting frame. The front contour cutting module 163 has a contour cutting frame disposed transversely to the transport path with a vertically disposed cutting wire D3. The contour cutting frame is moved to and fro transversely to the transport path by a drive module not shown in FIG. 24 which is located below the contour cutting frame.

Located along the transport path is a main conveying device which provides a first transport unit which moves the blocks forwards along the transport path and a second transport unit which moves the blocks backwards along the transport path. The first transport unit is mounted upstream of the contour cutting apparatus 160 and provides a rear block slider 164 which is movable to and fro along the rear contact plate 159 in the longitudinal direction of the transport path. The second transport unit is located downstream of the contour cutting apparatus 160 and provides a front block slider 165 which is movable to and fro along the front contact plate 161 in the longitudinal direction of the transport path. For better clarity only the block sliders 164 and 165 of the two transport units of the main conveying device are shown in FIG. 24.

In the main cutting station 158 a heart-shaped end product is cut out from the square block (B). FIG. 24 shows the block (B) on passing through the contour cutting apparatus 160. The block (B) lies with its rear third on the rear contact plate 159 and with its front two thirds on the front contact plate 161. Located behind the block (B) is the block slider 164 of the first transport unit of the main conveying device. Located in front of the block (B) is the block slider 165 of the second transport unit of the main conveying device. The block slider 164 of the first transport unit pushes the block (B) forwards from the rear contact plate 159 onto the front contact plate 161. The block slider 165 of the second transport unit pushes the block (B) from the front contact plate 161 backwards onto the rear contact plate 159.

On passing the contour cutting apparatus 160, the contour cutting frames of the two contour cutting modules 162, 163 are moved to and fro in the transverse direction. The rear contour cutting module 162 produces with its cutting wire D2 a contour cut S2 which runs along the right half of the end product outline. The front contour cutting module 163 produces with its cutting wire D3 a contour cut S3 which runs along the left half of the end product outline. FIG. 24 shows in thick lines the subsections of the two contour cuts S2, S3 which have already been executed. The subsections of the two contour cuts S2, S3 still to be executed are shown in thin lines.

During the production of the two contour cuts S2, S3 the block (B) is moved forwards from the block slider 164 of the first transport unit. The forward movement of the block (B) continues until the cutting wires D2, D3 of the two contour cutting modules 162, 164 which are moved to and fro in the transverse direction have arrived at the rear end of the heart-shaped end product. When the cutting wires D2, D3 have reached the apexes S2a, S3a of the two arcuate subsections of the contour cuts S2, S3, the block (B) is moved backwards a little way by the block slider of the second transport unit. The backward movement of the block (B) continues until the cutting wires D2, D3 moved inwards in the transverse direction have reached the longitudinal central axis of the block (B) and the two arcuate subsections of the contour cuts S2, S3 are completed. The block (B) is then moved forwards again by the block slider 164 of the first transport unit.

During the forward movement of the block (B), the cutting wires D2, D3 of the two contour cutting modules 162, 163 disposed on the longitudinal central axis of the block (B) produce the rectilinear end sections of the two contour cuts S2, S3. During the further forward movement of the block (B) the cutting wires D2, D3 of the two contour cutting modules 162, 163 emerge from the block (B) at the rear end of the block (B) and are received in the block slider 164 by a longitudinal slot 164a. At the end of the forward movement of the block (B) the cut block (B) lies on the front contact plate 161.

FIG. 25 shows a block which has been cut in the transverse direction and longitudinal direction in a system according to the invention. The block is divided into several strips (L) by straight cuts running in the transverse direction, which strips are disposed consecutively in the longitudinal direction. The block is additionally divided by contour cuts S1, S2, S3 running in the longitudinal direction. The contour cuts S1, S2, S3 divides the strips (L) into fan-shaped end products which are disposed in three longitudinal rows of 20 pieces each. The contour cuts S1 are shown by dashed lines with long strokes. The contour cuts S2 are shown by dashed lines with short strokes. The contour cuts S3 are shown by continuous lines.

FIG. 26 shows a rectangular block which has been cut in the longitudinal direction in a system according to the invention. The block contains fifteen end products configured as circular disks which are disposed in three longitudinal rows. The block has been cut by two batches of contour cuts each containing several subsections whose profile corresponds to a semicircle. FIG. 26 shows one batch of contour cuts in continuous lines and the other batch of contour cuts in dashed lines. FIG. 26 also shows the four strips which have been left during cutting of the block which extend in the longitudinal direction of the block. The longitudinal edges of the strips each contain several subsections whose contour corresponds to a semicircle.

FIG. 27 shows a contour cutting apparatus 166 which is disposed transversely to the transport path of the blocks. FIG. 27 shows the rear contact plate 167 of a main cutting station of a system according to the invention which is mounted upstream of the contour cutting apparatus 166. FIG. 27 shows the contact plate 167 in a vertical section through the transport path of the blocks. The contact plate 167 is disposed on the underside of the transport path. On the contact plate 167 a block (B) lies between two guide strips 168, 169. Located above the block (B) is a horizontal upper plate 170 which serves as a hold-down device for the block. The contour cutting apparatus 166 is equipped with a contour cutting module 171 which provides a cutting head 173 provided with a vertically disposed cutting tool 172. The cutting head 173 is located above the transport path. The cutting tool 172 passes through the transport path in the vertical direction. To produce the contour cuts the cutting head 173 is moved to and fro transversely to the transport path whilst a block is moved only forwards or forwards and backwards along the transport path. The profile of the contour cuts produced by the cutting head 173 is obtained from the combination of the longitudinal movements of the block (B) with the transverse movements of the cutting head 173. The cutting head 173 can be connected to a drive module which produces the transverse movements of the cutting head corresponding to the profile of the contour cut. The drive module can be a chain drive located transversely to the transport path. The drive module can be a recirculating ball screw drive located transversely to the transport path.

FIG. 28 shows another contour cutting apparatus 174 which is disposed transversely to the transport path of the blocks. FIG. 28 shows the rear contact plate 175 of a main cutting station of a system according to the invention mounted upstream of the contour cutting apparatus 174. FIG. 28 shows the contact plate 175 in a vertical section through the transport path of the blocks. The contact plate 175 is disposed on the underside of the transport path. On the contact plate 175 a block (B) lies between two guide strips 176, 177. Located above the block (B) is a horizontal upper plate 178 which serves as a hold-down device for the block. The contour cutting apparatus 174 is equipped with a contour cutting module 179 which provides a cutting head 181 provided with a vertically disposed cutting tool 180. The cutting head 181 is located above the transport path. The cutting tool 180 passes through the transport path in the vertical direction. The cutting head 181 is coupled to a linear motor 182 shown schematically in FIG. 28 which moves the cutting head 181 to and fro transversely to the transport path.

FIG. 29 shows schematically a first cutting station 183 in plan view. The first cutting station 183 is mounted upstream of the main cutting station in a system according to the invention. The first cutting station 183 provides a conveying device 184 for the blocks which is disposed along a rectilinear transport path along which a contact plate 185 for the blocks and a cutting apparatus 186 located transversely to the transport path are disposed consecutively. The conveying device 184 provides a block slider 187 which is displaceable in the longitudinal direction of the transport path which pushes the blocks lying on the contact plate 185 through the cutting apparatus 186. The blocks are cut into strips (L) on passing through the cutting apparatus 186.

FIG. 30 shows a variant of the first cutting station 188. This provides a cutting apparatus 191 disposed between a first contact plate 189 and a second contact plate 190, which has a cutting frame 192 disposed transversely to the transport path, which contains cutting wires 193 located obliquely to the transport path.

FIG. 31 shows a further variant of the first cutting station 194. This provides a cutting apparatus 197 located between a first contact plate 195 and a second contact plate 196 which is fitted with cutting tools located adjacently to one another transversely to the transport path, which are configured as circular saws with vertically disposed circular saw blades 198.

FIG. 32 shows a longitudinal section through a main cutting station 199. In this station a rear contact plate 200, a contour cutting apparatus 201 and a front contact plate 202 are disposed consecutively along a rectilinear transport path. The contour cutting apparatus 201 is disposed transversely to the transport path and contains a contour cutting frame 203 which is movable transversely to the transport path and contains at least one vertical cutting wire. The contour cutting frame 203 is moved to and fro transversely to the transport path by a drive module (not shown in FIG. 32).

FIG. 32 shows a block (B) on passing through the contour cutting apparatus 201. The block (B) lies partly on the rear contact plate 200 and already partly on the front contact plate 202.

A main conveying devices located along the transport path is provided in the main cutting station 199. The main conveying device provides a first transport unit 204 mounted upstream of the rear contact plate 200, which has a block slider 205 located above the rear contact plate 200 which is disposed above the rear contact plate 200 after the block (B). The block slider 205 is moved forwards and backwards along the transport path by a linear motor 206. The main conveying device provides a second transport unit 207 mounted downstream of the front contact plate 202 which has a block slider 208 located above the front contact plate 202 which is located above the front contact plate 202 in front of the block (B). The block slider 208 is moved forwards and backwards along the transport path by a linear motor 209.

In the main cutting station 199 the block (B) is moved forwards and backwards along the transport path by the block sliders 205, 208 of the two transport units 204, 207 whilst in the contour cutting apparatus 201 the contour cutting frame 203 containing at least one vertical wire is moved to and fro transversely to the transport path. In the contour cuts produced by the contour cutting apparatus 201 the transverse movements of the contour cutting frame 203 are combined with the longitudinal movements of the block. The combination of the two movements determines the profile of the contour cut. In this combination the transverse movements of the contour cutting frame 203 corresponding to the profile of the contour cut are combined with the longitudinal movements of the block corresponding to the profile of the contour cut.

The transverse movements of the contour cutting frame 203 corresponding to the profile of the contour cut are produced by a drive module connected to the contour cutting frame 203 which contains a drive motor generating the transverse movements of the contour cutting frame 203 in which the production of the movements of the contour cutting frame running in the transverse direction of the system during the contour cut is integrated in the control program of the linear motor.

The longitudinal movements of the block corresponding to the profile of the contour cut are produced by the two transport units 204, 207 which move their block sliders 205, 208 forwards and backwards along the transport path according to the profile of the contour cut with the aid of the linear motors 206, 209. The production of the backward movements of the block sliders 205, 208 corresponding to the profile of the contour cut is integrated in the control programs of the linear motors 206, 209 of the transport units 204, 207.

1-47. (canceled)

48. A system for producing end products by cutting flat blocks, the system comprising:
an input station for the flat blocks, at least one cutting station for cutting the blocks, and a dispensing station for dispensing end products;
said at least one cutting station including a main cutting station with a contour cutting apparatus configured to cut the blocks through contour cuts;
said contour cutting apparatus being disposed transversely to a rectilinear transport path extending in a longitudinal direction of the system;
a main conveying device for the blocks disposed along the transport path in said main cutting station;
said contour cutting apparatus including at least one contour cutting module provided with at least one cutting tool to be moved to and fro in the transverse direction of the system, for producing a contour cut in the blocks passing said contour cutting apparatus in the longitudinal direction of the system.

49. The system according to claim 48, wherein said contour cutting apparatus comprises two contour cutting modules which are disposed consecutively in the longitudinal direction of the system and which produce two mutually different contour cuts.

50. The system according to claim 48, wherein said at least one contour cutting module of said contour cutting apparatus is one of three three contour cutting modules disposed consecutively in the longitudinal direction of the system and configured to produce three different contour cuts.

51. The system according to claim 48, wherein a cutting head which is movable in the transverse direction of the system is provided as a contour cutting module which carries at least one vertically disposed cutting tool that passes through the transport path of the blocks in a vertical direction.

52. The system according to claim 51, wherein said contour cutting module comprises a drive module connected to said cutting head which during the contour cut produces movements of said cutting head in the transverse direction of the system.

53. The system according to claim 52, wherein said drive module comprises a contour template defining the movements of said cutting head running in the transverse direction of the system during the contour cut.

54. The system according to claim 52, wherein said drive module is coupled to a copying device configured to acquire a contour of the end product from a contour template or from an original model.

55. The system according to claim 52, wherein said drive module comprises a movement device configured to move said cutting head to and fro in the transverse direction of the system, wherein said movement device is coupled to a drive motor, and wherein a generation of the movements of said cutting head in the transverse direction of the system during the contour cut is integrated in a control program of said drive motor.

56. The system according to claim 52, wherein said drive module comprises a linear motor configured to move said cutting head to and fro in the transverse direction of the system, and wherein a generation of the movements of said cutting head in the transverse direction of the system during the contour cut is integrated in a control program of said linear motor.

57. The system according to claim 48, wherein said at least one contour cutting module is a contour cutting module in which a contour cutting frame that is movably disposed in the transverse direction of the system contains at least one vertically disposed cutting wire and is connected to a drive module which produces movements of said contour cutting frame in the transverse direction of the system during the contour cut.

58. The system according to claim 57, wherein said drive module contains a contour template from which movements of said contour cutting frame in the transverse direction of the system during the contour cut are acquired.

59. The system according to claim 57, wherein said drive module is coupled to a copying device configured to acquire a contour of the end product from a contour template or from an original model.

60. The system according to claim 57, wherein said drive module comprises a movement device coupled to a drive motor which moves the contour cutting frame to and fro in the transverse direction of the system and wherein a generation of the movements of the contour cutting frame in the transverse direction of the system during the contour cut is integrated in a control program of the drive motor.

61. The system according to claim 60, wherein said drive motor is a servo motor and the movement device is a recirculating ball screw drive).

62. The system according to claim 57, wherein said drive module comprises a linear motor configured to move said contour cutting frame to and fro in the transverse direction of the system, and wherein a generation of the movements of said contour cutting frame running in the transverse direction of the system during the contour cut is integrated in a control program of the linear motor.

63. The system according to claim 57, wherein said contour cutting frame contains two or more vertically disposed cutting wires disposed at a spacing distance from one another in the transverse direction of the system.

64. The system according to claim 48, wherein said contour cutting apparatus comprises at least one additional cutting module having at least one stationary cutting tool configured to produce a straight cut in the blocks parallel to the longitudinal direction of the system.

65. The system according to claim 64, wherein said additional cutting module comprises a stationary cutting frame with at least one substantially vertically disposed cutting wire.

66. The system according to claim 48, which further comprises a rear contact plate mounted directly upstream of said contour cutting apparatus.

67. The system according to claim 66, which further comprises an upper plate above said rear contact plate, said upper plate being optionally height-adjustable and disposed to upwardly delimit the transport path.

68. The system according to claim 66, which comprises at least one guide strip above said rear contact plate for delimiting the transport path laterally (optional: at least one guide strip on each side of the transport path).

69. The system according to claim 48, which comprises a front contact plate disposed directly downstream of said contour cutting apparatus.

70. The system according to claim 69, which further comprises an upper plate disposed above said front contact plate, said upper plate being optionally height-adjustable and configured to upwardly delimit the transport path at the top.

71. The system according to claim 69, which further comprises at least one guide strip above said front contact plate delimiting the transport path laterally (optional: at least one guide strip disposed on each side of the transport path).

72. The system according to claim 48, wherein the rectilinear transport path runs in the longitudinal direction of the system and extends from said input station through said main cutting station and into said dispensing station, said contour cutting apparatus is disposed in said main cutting station transversely to the rectilinear transport path and an endless product conveyor belt is disposed downstream of said contour cutting apparatus for receiving the end products, said endless product conveyor belt extending along the rectilinear transport path into said dispensing station of the system.

73. The system according to claim 72, which further comprises an upper plate disposed above said product conveyor belt, said upper plate being optionally height-adjustable and configured to delimits the transport path upwardly above said product conveyor belt.

74. The system according to claim 72, which further comprises at least one guide strip disposed to laterally delimit the transport path above said product conveyor belt (optional: at least one guide strip disposed on each side of the transport path).

75. The system according to claim 72, which comprises a first cutting station for cutting the blocks in the transverse direction of the system mounted upstream of said main cutting station, said first cutting apparatus having blades disposed to be moved to and fro transversely to the transport path is provided.

76. The system according to claim 48, wherein said main conveying device comprises a rear contact plate and a transport unit mounted upstream of said contour cutting apparatus, said transport unit is configured to move the blocks forward along the rectilinear transport path in the longitudinal direction of the system and includes a rear block slider which is displaceable along said rear contact plate in the longitudinal direction of the system.

77. The system according to claim 76, which comprises an endless product conveyor belt disposed downstream of said contour cutting apparatus, said endless product conveyor belt being disposed to receive the end products and extending into the dispensing station of the system.

78. The system according to claim 76, which comprises a front contact plate disposed downstream of said contour cutting apparatus and a transverse slider which is displaceable along said front contact plate in the transverse direction of the system.

79. The system according to claim 48, wherein said contour cutting apparatus is disposed between a rear contact plate and a front contact plate and said main conveying device comprises a first transport unit upstream of said rear contact plate and a second transport unit downstream of said front contact plate, wherein said first transport unit moves the blocks forward in the longitudinal direction of the system and includes a rear block slider displaceably mounted along said rear contact plate in the longitudinal direction of the system and wherein said second transport unit moves the blocks backwards in the longitudinal direction of the system and includes a front block slider displaceably mounted along said front contact plate in the longitudinal direction of the system.

80. The system according to claim 79, which comprises a transverse slider displaceably mounted along said front contact plate in the transverse direction of the system.

81. The system according to claim 79, which comprises a transverse slider displaceably mounted along said rear contact plate in the transverse direction of the system.

82. The system according to claim 79, wherein said first transport unit comprises a drive module connected to said rear block slider which, during the contour cut, produces movements of said rear block slider in the longitudinal direction of the system.

83. The system according to claim 82, wherein said drive module of said first transport unit includes a movement device coupled to a drive motor, which moves said rear block slider to and fro in the longitudinal direction of the system, and wherein a generation of the movements of said rear block slider running in the longitudinal direction of the system during the contour cut is integrated in a control program of said drive motor.

84. The system according to claim 83, wherein said drive motor of said drive module of said first transport unit is a servo motor and said movement device is configured as a recirculating ball screw drive that extends in the longitudinal direction of the system.

85. The system according to claim 79, wherein said first transport unit comprises a linear motor coupled to said rear block slider for moving said rear block slider to and fro in the longitudinal direction of the system, and wherein a generation of the movements of said rear block slider in the longitudinal direction of the system during the contour cut is integrated in a control program of said linear motor.

86. The system according to claim 79, wherein said second transport unit includes a drive module connected to said front block slider and configured to produce the movements of said front block slider in the longitudinal direction of the system during the contour cut.

87. The system according to claim 86, wherein said drive module of said second transport unit includes a movement device coupled to a drive motor for moving said front block slider to and fro in the longitudinal direction of the system, and wherein a generation of the movements of said front block slider running in the longitudinal direction of the system during the contour cut is integrated in a control program of the drive motor.

88. The system according to claim 87, wherein said drive motor of said drive module of said second transport unit is a servo motor and said movement device is configured as a recirculating ball screw drive that extends in the longitudinal direction of the system.

89. The system according to claim 79, wherein said second transport unit includes a linear motor coupled to said front block slider for moving said front block slider to and fro in the longitudinal direction of the system, and wherein a generation of the movements of the front block slider in the longitudinal direction of the system during the contour cut is integrated in a control program of the linear motor.

90. The system according to claim 76, which comprises a feed device for feeding the blocks to said rear contact plate of said main cutting station in the transverse direction of the system.

91. The system according to claim 76, which comprises a first cutting station for cutting the blocks in the transverse direction of the system, wherein said blocks are pushed in the transverse direction of the system through a stationary cutting apparatus, wherein said first cutting station is mounted upstream of said main cutting station in the transverse direction of the system, and wherein the blocks emerging from said first cutting station in the transverse direction of the system are fed to said main cutting station in the transverse direction of the system.

92. The system according to claim 91, wherein said first cutting station includes a cutting apparatus disposed transversely to the direction of movement of the blocks and extending in the longitudinal direction of the system, and wherein said cutting apparatus has two or more cutting tools disposed at a spacing distance from one another in the longitudinal direction of the system.

93. The system according to claim 91, wherein said cutting apparatus of said first cutting station includes a cutting tool in the form of a stationary circular saw with a circular saw blade disposed to rotate about a horizontal axis.

94. The system according to claim 91, wherein said cutting apparatus of said first cutting station includes a stationary cutting frame that extends in the longitudinal direction of the system and contains two or more substantially vertically disposed cutting wires.
